(19) United States
(12) Patent Application Publication
(10) Pub. No.: US 2024/0308914 A1
(43) Pub. Date: Sep. 19, 2024

(54) NAILABLE CONCRETE COMPOSITION

(71) Applicant: UNIVERSITY OF SOUTH FLORIDA, Tampa, FL (US)

(72) Inventor: John Michael Cotter, Tampa, FL (US)

(21) Appl. No.: 18/183,271

(22) Filed: Mar. 14, 2023

(51) Int. Cl. C04B 28/04; C04B 14/06; C04B 18/22; C04B 40/00

(52) U.S. Cl. CPC C04B 28/04; C04B 14/06; C04B 18/22; C04B 40/0042; C04B 2111/00594; C04B 2111/60

(57) ABSTRACT

Disclosed herein is a concrete composition comprising: a) a cement in an amount of about 25 wt % to about 70 wt % based on a total mass of dry material; b) a rubber in an amount of about 15 wt % to about 35 wt % on a total mass of dry material; and c) fine aggregates in an amount of about 10 wt % to about 35 wt % on a total mass of dry material; wherein the concrete composition is substantially free of coarse aggregates. Additionally, articles comprising the disclosed herein composition are also disclosed. Also disclosed are methods of making the compositions and the articles.

### FIELD

The subject matter disclosed herein generally relates to a nailable and/or screwable concrete. Also, the subject matter described herein generally relates to articles comprising such concrete. Also, the subject matter described herein generally relates to methods of making such concrete and articles comprising the sarne.

### BACKGROUND

Since the beginning of civilization, lumber has been utilized as a structural material due to unique properties such as low-cost and easy workability. However, lumber has several limitations in application due to warping (which is significant and prevents its use in many applications), rotting, insect damage potential, etc. Also, while lumber is produced from renewable timber, it takes many years to grow the trees. The shortage of land on which forestry can be developed to provide enough timber combined with the high demand for low-cost timber resulted in a multi-billion dollar business of illegal and unsustainable logging in forests worldwide. According to some estimates, logging in violation of national laws accounts for 8-10% of global production and trade in forest products. It also represents 40-50% of all logging in some of the earth's most valuable and threatened forests.

Thus there is an urgent need to find sustainable alternatives that can overcome these limitations of lumber.

Concrete is the most widely used construction material. The global use of concrete is second only to water, accounting for 70% of all building and construction materials. However, concrete used today in the industry cannot be used as wood, as it is not adapted for nails and/or screws without powerful equipment that would insert nails and screws into it or without a special drilling preparation.

Thus, new concrete compositions that can accept nails and screws similar to wood are needed to replace the lumber. The compositions, articles comprising such compositions and methods of making the compositions that address these and other needs are disclosed herein.

### SUMMARY

In accordance with the purposes of the disclosed materials, compounds, compositions, and methods, as embodied and broadly described herein, the disclosed subject matter, in one aspect, relates to compounds and compositions and methods for preparing and using such compounds and compositions.

In some aspects disclosed herein is a concrete composition comprising: a) a cement in an amount of about 25 wt % to about 70 wt % based on a total mass of dry material; b) a rubber in an amount of about 15 wt % to about 35 wt % on a total mass of dry material; and c) fine aggregates in an amount of about 10 wt % to about 35 wt % on a total mass of dry material; wherein the concrete composition is substantially free of coarse aggregates.

In some aspects, the rubber is virgin and/or recycled and has a particle size no greater than about 0.5 inches.

In yet still further aspects, the concrete composition comprises water in an amount of about 20 wt % to about 40 wt % based on the water-to-cement ratio.

Also disclosed herein is an article comprising a concrete composition comprising: a) a cement in an amount of about 25 wt % to about 70 wt % based on a total mass of dry material; b) a rubber in an amount of about 15 wt % to about 35 wt % on a total mass of dry material; c) fine aggregates in an amount of about 10 wt % to about 35 wt % on a total mass of dry material; and d) water in an amount of about 20 wt % to about 40 wt % on a water-to-cement ratio; wherein the concrete composition is substantially free of coarse aggregates.

In still further aspects, the disclosed herein articles is nailable and/or screwable and exhibit a nail and/or screw insertion shear stress of about 500 to about 1200 pounds per square inch and nail and/or screw withdrawal or pullout stress of about 150 to about 1450 pounds per square inch.

In some aspects, disclosed herein is a method comprising: a) mixing a composition comprising: i) a cement in an amount of about 25 wt % to about 70 wt % based on a total mass of dry material; ii) a rubber in an amount of about 15 wt % to about 35 wt % on a total mass of dry material; and iii) fine aggregates in an amount of about 10 wt % to about 35 wt % on a total mass of dry material to form a concrete composition; b) mixing concrete composition with water in an amount of about 20 wt % to about 40 wt % on a water-to-cement ratio to form concrete.

Additional advantages will be set forth in part in the description that follows and in part will be obvious from the description or may be learned by practice of the aspects described below. The advantages described below will be realized and attained by means of the elements and combinations particularly pointed out in the appended claims. It is to be understood that both the foregoing general description and the following detailed description are exemplary and explanatory only and is not restrictive.

### BRIEF DESCRIPTION OF THE FIGURES

The accompanying figures, which are incorporated in and constitute a part of this specification, illustrate several aspects described below.

FIG. 1 is an exemplary nailable rubber concrete board.

FIG. 2 depicts an exemplary concrete article in various conditions. The top section has the reinforcement fully tied together, the middle section has been cast, and the bottom section has a single layer of hardware cloth with the wire being cut in preparation for tying the reinforcement wire to the first layer.

FIGS. 3A-3F depict the steps of one method of manufacturing samples.

FIG. 4 depicts an exemplary steel formwork system that could allow greater production rates for the labor provided, helping to make the technology much more economical.

FIG. 5 depicts an exemplary jig for keeping the shear reinforcement in place during the fabrication of a wire cage. The image at the right shows that these rods have an extended length outside the jig.

FIG. 6 shows exemplary stirrup cages that are bent into a shape using the protrusions of the rods outside of the jig. This allows for approximate bending of the shear reinforcement ties.

FIG. 7 shows exemplary longitudinal rods that are marked prior to placing them in the jig. Once in the jig, the ties are slid over the rods before pushing the rods through the far end of the jig. The ties can then be spaced as marked.

FIGS. 8A-8C show various reinforcement elements. FIG. 8A shows a reinforcement cage that is glued together. FIG. 8B shows an alternate method of tac welding shear reinforcement. The upper left shows the wire cage with half the shear reinforcement sliding into place. The upper right shows the grounding clamp installed. The bottom left shows the first tac weld, affixing one point of the shear reinforcement to the longitudinal wire. The bottom right shows one of the connections on each individual shear reinforcement tac welded. FIG. 8C shows an example of a partially assembled wire cage that was tac welded in four locations on each shear reinforcement element.

FIGS. 9A-9B show exemplary beams. FIG. 9A shows exemplary beams 1-5 before casting. Reinforcement cages, which are glued together using hot melt adhesive, as shown out of the formwork as well as inside the formwork. The cages are approximately 9.75 inches long, with the individual test beams being 10 inches in length. FIG. 9B shows exemplary beams 6-9 before casting.

FIGS. 10A-10E show test results of the exemplary RC-9 beam as well as other beams. FIG. 10A shows the performance of RC-9, the beam with welded shear reinforcement and threaded rods in comparison to RC-8, with which hot melt adhesive was used to secure the shear reinforcement to threaded longitudinal rods and RC-1, RC-2, and RC-3, which use smooth longitudinal rods and hot melt adhesive to secure shear reinforcement. A substantial increase in strength was noted in RC-9. FIG. 10B shows the exemplary RC-9 beam that failed. FIG. 10C shows the exemplary failed RC-8 beam after it was cut in half. The red, transparent section is shown to indicate where the beam was cut in half. The shear reinforcement has shifted forward. FIG. 10D shows the exemplary RC-8 beam with longitudinal reinforcement. The red arrows and lines indicate where the longitudinal reinforcement shifted forward. FIG. 10E shows an example of the failed RC-3 beam. The arrow is pointing to a location where the lower part of a shear reinforcement tie is supposed to be located but has shifted, causing a premature failure.

FIG. 11 shows a setup for nail withdrawal or pullout testing.

FIGS. 12A-12C show various test results. FIG. 12A shows the smooth shank tests for all samples with the data shifted for alignment. FIG. 12B shows only the wood control sample strengths. FIG. 12C shows only the nailable rubber concrete (NRC) test results.

FIG. 13 shows the exemplary NRC samples compared against the control wood beams.

FIG. 14 shows the test results after shifting. The notation np refers to nail-pullout (withdrawal of a nail), em refers to electromagnetic nailing (i.e., using the Metabo Cordless Nailer), and h refers to the only sample in which the nail was driven by a hammer.

FIG. 15 shows the wood control graphs only.

FIG. 16 shows the ring shank nail withdrawal (pullout) comparison of the exemplary NRC beam and wood control.

FIG. 17 shows exemplary RC-5 samples with a screw driven into the depth with the concrete broken out underneath. The cracking on the surface of the concrete was noted.

FIG. 18 shows the graphs for all samples with shifting to cause the withdrawal (pullout) distance to load to match more accurately.

FIGS. 19A-19B show exemplary withdrawal (pullout) tests in one aspect. FIG. 19A shows the wood control results for screw withdrawal (pullout). FIG. 19B shows the test results for screw withdrawal (pullout) for the exemplary NRC samples compared to wood.

FIG. 20 shows the exemplary nail insertion tests for the wood control beams and an NRC beam.

FIGS. 21A-21I show the cavities formed by the three types of fasteners are shown. The first row (FIGS. 21A-21C) contains the unpainted cavity; in order to highlight the cavity, rows 2 (FIGS. 21D-21F) and 3 (FIGS. 21G-21I) have been painted except for the cavity formed. Row 3 (FIGS. 21G-21I) includes a 1/64″ graduated ruler for cavity size comparison. Column 1 represents the smooth shank nails, column 2 represents the ring shank nails, and column 3 represents the screws.

FIGS. 22A-22D show an example of the cavity formed by pulling nails out of a sample of concrete. These samples are from the older style of board, which contains much less reinforcement but are dimensionally larger and has less of a tendency to crack upon inserting the nail. These fasteners were driven and then abrasively cut with a chop saw.

### DETAILED DESCRIPTION

The materials, compounds, compositions, articles, and methods described herein may be understood more readily by reference to the following detailed description of specific aspects of the disclosed subject matter, and the Examples included therein.

Before the present materials, compounds, compositions, kits, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entirety are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### Definitions

In this specification and in the claims that follow, reference will be made to a number of terms, which shall be defined to have the following meanings:

As used herein, the terms “optional” or “optionally” means that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms that shall be defined herein.

For the terms “for example” and “such as” and grammatical equivalences thereof, the phrase “and without limitation” is understood to follow unless explicitly stated otherwise. It is further understood that these phrases are used for explanatory purposes only. It is further understood that the term “exemplary,” as used herein, means “an example of” and is not intended to convey an indication of a preferred or ideal aspect.

The term “or” means “and/or.” Recitation of ranges of values is merely intended to serve as a shorthand method of referring individually to each separate value falling within the range unless otherwise indicated herein, and each separate value is incorporated into the specification as if it were individually recited herein. The endpoints of all ranges are included within the range and independently combinable. All methods described herein can be performed in a suitable order unless otherwise indicated herein or otherwise clearly contradicted by context.

Recitation of ranges of values herein is merely intended to serve as a shorthand method of referring individually to each separate value recited or falling within the range unless otherwise indicated herein, and each separate value is incorporated into the specification as if it were individually recited. Ranges provided herein are understood to be shorthand for all of the values within the range. For example, a range of 1 to 50 is understood to include any number, or combination of numbers, from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 or sub-ranges from the group consisting of 10-40, 20-50, 5-35, etc. Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4).

The term “nailability” refers to the material's ability to function such that nails can be driven, by hand using a hammer, into the material without damaging the material excessively and with adequate withdrawal (pullout) strength to allow the material to be installed for structural applications. The penetration and withdrawal (pullout) force should be similar to the values of these variables for commonly used structural lumber species, such as Douglas fir, white pine, southern yellow pine, etc. A material is referred to as being nailable if it has attained the properties necessary to meet a nailability requirement. It is understood that if nails can be driven by hand using a hammer, then nails will drive appropriately using a pneumatic or cordless nailer or nail gun. Similarly, the term “screwability” refers to the material's ability to function such that screws, such as wood screws, for example, can be driven, by hand using a screwdriver, into the material without damaging the material excessively and with adequate withdrawal (pullout) strength to allow the material to be installed for structural applications.

It is understood that the terms “withdrawal” and “pullout,” as referred to herein, can be used interchangeably.

As used herein, the term “recycled” refers to leftovers of materials that are not in use anymore.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

It will be understood that although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition or based on any other calculations as disclosed.

As used herein, the term “substantially,” in, for example, the context “substantially identical” or “substantially similar,” refers to a method or a system, or a component that is at least about 90%, at least about 91%, at least about 92%, at least about 93%, at least about 94%, at least about 95%, at least about 96%, at least about 97%, at least about 98%, at least about 99%, or about 100% by similar to the method, system, or the component it is compared to.

As used herein, the terms “substantially identical reference composition” and “substantially identical reference article” refer to a reference composition or article comprising substantially identical components in the absence of an inventive component. In another exemplary aspect, the term “substantially,” in, for example, the context “substantially identical reference composition” or “substantially identical reference article,” refers to a reference composition or an article comprising substantially identical components and wherein an inventive component is absent or is substituted with a common in the art component.

By “contact” or other forms of the word, such as “contacted” or “contacting,” it is meant to add, combine, or mix two or more compounds, compositions, or materials under appropriate conditions to produce a desired product or effect. The term “react” is sometimes used when “contacting” results in a chemical reaction.

While aspects of the present invention can be described and claimed in a particular statutory class, such as the system statutory class, this is for convenience only, and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Compositions

As discussed in detail above, the use of lumber represents multiple challenges in today's economic environment and therefore, concrete can be used as an alternative material that meets the strength requirements of wood but uses materials that are significantly less prone to the issues affecting the wood. Due to a high infill of recycled material, the cost of concrete can be reduced to meet the cost of wood products.

The nailable and/or screwable concrete compositions described herein can be installed similarly to the wood. In certain aspects, once nailed together, the concrete can last substantially longer than a pressure-treated wood product.

In still further aspects and as described in detail below, the longevity of the described herein nailable and/or screwable concrete composition can be extended by introducing reinforcement elements that have anti-corrosion properties, as well as using fasteners that were treated to reduce corrosion.

Still further and as described below, the described herein concrete compositions can have improved strength. Such improved strength can be provided by increasing the reinforcement of the desired section of the concrete article.

Disclosed herein are materials, compounds, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a composition is disclosed and a number of modifications that can be made to a number of components of the composition are discussed, each and every combination and permutation that are possible are specifically contemplated unless specifically indicated to the contrary. Thus, if a class of components A, B, and C are disclosed and a class of components D, E, and F and an example of a combination composition A-D are disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from the disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure, including, but not limited to, steps in methods of making and using the disclosed compositions. Thus, if there are a variety of additional steps that can be performed, it is understood that each of these additional steps can be performed with any specific aspect or combination of aspects of the disclosed methods, and that each such combination is specifically contemplated and should be considered disclosed.

In certain aspects, disclosed herein is a concrete composition comprising: a) a cement in an amount of about 25 wt % to about 70 wt % based on a total mass of dry material; b) a rubber in an amount of about 15 wt % to about 35 wt % on a total mass of dry material; and c) fine aggregates in an amount of about 10 wt % to about 35 wt % on a total mass of dry material; wherein the concrete composition is substantially free of coarse aggregates.

In such aspects, the cement can be present in an amount of about 25 wt % to about 70 wt %, including exemplary values of about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, and about 69.9 wt %, based on a total mass of dry material.

In still further aspects, the cement can be any known in the art cementitious materials suitable for the desired application can be used. In some aspects, the cement can comprise portland cement, calcium aluminate cement, calcium silicate, magnesium silicate, calcium phosphate cement, calcium aluminate sulfonate cement, fly ash, silica fume, slaked lime, cement kiln dust, limestone fines, ground granulated blast furnace slag, recycled cement mixtures, cement waste, and combinations of thereof. In still further aspects, the cement is portland cement.

Yet still, any other known in the art cement can be utilized in this disclosure. For example, the cement can be chosen from portland cement, portland cement blends (portland blast-furnace slag cement, or blast furnace cement, portland-fly ash cement, portland pozzolan cement, portland silica fume cement, masonry cement, expansive cement, white blended cement, and very finely ground types of cement), pozzolan-lime cement, slag-lime cement, supersulfated cement, calcium sulfoaluminate cement, geopolymer cement, polymer cement, Sorel cement (named by the chemist Stanislas Sorel), limestone cement, and hydraulic cement and non-hydraulic cement.

In still further aspects, the rubber in an amount of about 10 wt % to about 60 wt %, including exemplary values of about 15 wt %, about 20 wt %, about 25 wt %, about 30 wt %, about 35 wt %, about 40 wt %, about 45 wt %, about 50 wt %, and about 55 wt % on a total mass of dry material. While in still further aspects, the rubber is present in an amount of about 15 wt % to about 35 wt %, including exemplary values of about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, and about 34 wt % on a total mass of dry material.

Yet in still further aspects, the rubber can be present in an amount of about 20 wt % to about 140 wt % based on the weight of the cement, including exemplary values of about 30 wt %, about 40 wt %, about 50 wt %, about 60 wt %, about 70 wt %, about 80 wt %, about 90 wt %, about 100 wt %, about 110 wt %, about 120 wt %, and about 130 wt % based on the weight of the cement.

It is understood that the rubber can be used as is, or it can be pretreated prior to use in the concrete. Any known in the art methods of pretreatment can be utilized. For example, and without limitations, the rubber can be treated with cement (to increase adherence, for example), treated with acids (sulfuric, hydrochloric, nitric, etc.), and treated with bases (sodium hydroxide, potassium hydroxide, etc.). It is understood that the examples provided herein include pretreated and non-treated rubber.

In still further aspects, the concrete composition can comprise fine aggregates in an amount of about 10 wt % to about 35 wt %, including exemplary values of about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, and about 34 wt % on a total mass of dry material.

It is understood that cement, rubber, and fine aggregates can be present in any ratio to each other.

In some exemplary and unlimiting aspects, the composition can comprise fine aggregates-to-cement-to-rubber in a ratio of 5:8:15 or 3:4:8 by volume. In other exemplary and unlimiting aspects, the composition can comprise fine aggregates-to-cement-to-rubber in a ratio of 5:18:26 or 1:3:4 by volume. In yet still further exemplary and unlimiting aspects, the composition can comprise fine aggregates-to-cement-to-rubber in a ratio of 1:1.6:3 based on volume or 1:3.6:5.2 based on volume. It is understood that, in some aspects, volumetric ratios can be used. The use of volumetric ratios can be useful when the mixture is prepared in the field during the mixing of the components. In such exemplary and unlimiting aspects, the shovels” or “shovel-fulls” can be used as measurement units.

In yet still further exemplary and unlimiting aspects, the composition can comprise fine aggregates-to-cement-to-rubber in a ratio of 7:11:5 by weight. In yet still further exemplary and unlimiting aspects, the composition can comprise fine aggregates-to-cement-to-rubber in a ratio of 20:68:25 by weight. In yet still further exemplary and unlimiting aspects, the composition can comprise fine aggregates-to-cement-to-rubber in a ratio of 1.4:2.2:1 based on weight or mass or 1:3.4:1.25 based on weight or mass.

In yet still further exemplary and unlimiting aspects, the composition can comprise fine aggregates-to-cement-to-rubber in a ratio of 3:14:12 or 7:8:1 by volume. In yet still further exemplary and unlimiting aspects, the composition can comprise fine aggregates-to-cement-to-rubber in a ratio of 2:11:28 or 7:6:28 by volume. In yet still further exemplary and unlimiting aspects, the composition can comprise fine aggregates-to-cement-to-rubber in a ratio of 7:10:12 by volume.

In still further aspects, the disclosed herein cement compositions are substantially free of coarse aggregates. It is understood that common cement compositions comprise aggregates that are fine aggregates having a diameter of less than about 9.5 mm and coarse aggregates having a diameter of about 9.5 mm to about 40 mm. The aggregates, in general, can comprise natural sand, silicone sand, crushed stone, recycled foundry sand, bottom ash, slag, gravel, recycled concrete, glass, limestone, granite, and the like, and any combination thereof.

In still further aspects, the fine aggregates present in the disclosed composition comprise any known aggregates having a size smaller than about 9.5 mm, smaller than about 9 mm, smaller than about 8.5 mm, smaller than about 8 mm, smaller than about 7.5 mm, smaller than about 7 mm, smaller than about 6.5 mm, smaller than about 6 mm, smaller than about 5.5 mm, smaller than about 5 mm, smaller than about 4.5 mm, smaller than about 4 mm, smaller than about 3.5 mm, smaller than about 3 mm, smaller than about 2.5 mm, smaller than about 2 mm, smaller than about 1.5 mm, smaller than about 1 mm, or smaller than about 0.5 mm. In still further aspects, the fine aggregates present in the disclosed composition can have a size greater than 0 to about 9.5 mm, including exemplary values of about 0.5 mm, about 1 mm, about 1.5 mm, about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, and about 9 mm.

In still further aspects, the fine aggregates present in the disclosed herein compositions are sand. Again it is understood that sand can be natural sand, silicone sand, recycled foundry sand, and the like.

In aspects disclosed herein, the cement composition is substantially free of coarse aggregates a size larger than about 9 mm, larger than about 9.5 mm, larger than about 10 mm, larger than about 10.5 mm, larger than about 11 mm, larger than about 11.5 mm, larger than about 12 mm, larger than about 12.5 mm, larger than about 13 mm, larger than about 13.5 mm, larger than about 14 mm, larger than about 14.5 mm, larger than about 15 mm, larger than about 15.5 mm, larger than about 16 mm, larger than about 16.5 mm, larger than about 17 mm, larger than about 17.5 mm, larger than about 18 mm, larger than about 18.5 mm, larger than about 19 mm, larger than about 19.5, larger than about 20 mm, larger than about 20.5 mm, larger than about 21 mm, larger than about 21.5 mm, larger than about 22 mm, larger than about 22.5 mm, larger than about 23 mm, larger than about 23.5 mm, larger than about 24 mm, larger than about 24.5 mm, larger than about 25 mm, larger than about 25.5 mm, larger than about 26 mm, larger than about 26.5 mm, larger than about 27 mm, larger than about 27.5 mm, larger than about 28 mm, larger than about 28.5 mm, larger than about 29 mm, larger than about 29.5 mm, larger than about 30 mm, larger than about 30.5 mm, larger than about 31 mm, larger than about 31.5 mm, larger than about 32 mm, larger than about 32.5 mm, larger than about 33 mm, larger than about 33.5 mm, larger than about 34 mm, larger than about 34.5 mm, larger than about 35 mm, larger than about 35.5 mm, larger than about 36 mm, larger than about 36.5 mm, larger than about 37 mm, larger than about 37.5 mm, larger than about 38 mm, larger than about 38.5 mm, larger than about 39 mm, or larger than about 39.5 mm.

In yet other aspects, the concrete composition described herein is substantially free of coarse aggregates having a size of about 9.5 mm to about 40 mm, including exemplary values of about 10 mm, about 12 mm, about 15 mm, about 17 mm, about 20 mm, about 22 mm, about 25 mm, about 27 mm, about 30 mm, about 32 mm, about 35 mm, and about 37 mm.

In still further aspects, the coarse aggregates disclosed herein can comprise gravel, crushed rock, crushed limestone, crushed recycled concrete, crushed granite and the like. In still further aspects, the disclosed herein compositions are substantially free of rock aggregates.

In still further aspects, the rubber present in the concrete composition can be virgin. Yet, in other aspects, the rubber can be recycled. It is understood that the term “virgin” refers to rubbers as produced. In still further aspects, recycled rubber can be post-consumer recycled rubber or post-manufacturing recycled rubber. It is understood that post-manufacturing recycled rubber includes waste rubber, unused rubber, discarded good rubbers, unused rubber that does not pass quality control inspection and the like.

In still further aspects, recycled rubber can comprise recycled tires, tire buffing, recycled conveyor belts, rubber clothing, rubber gloves, rubber mats, rubber flooring, rubber seals, rubber gaskets, rubber hoses, or any combination thereof.

In still further aspects, the recycled rubber that is used in the concrete compositions disclosed herein does not have to be cleaned or purified. In such aspects, recycled rubber can comprise at least some amount of recycled material that is not rubber. For example, and without limitations, if the recycled rubber is recycled tires or conveyor belts, such rubber can contain recycled metals, nails, staples, other polymers, fabrics, and the like.

In still further aspects, the rubber present in the compositions disclosed herein has a particle size no greater than about 0.5 inches, no greater than about 0.45 inches, no greater than about 0.4 inches, no greater than about 0.35 inches, no greater than about 0.3 inches, no greater than about 0.25 inches, no greater than about 0.2 inches, no greater than about 0.15 inches, no greater than about 0.1 inches, or no greater than about 0.05 inches. In yet still further aspects, the rubber present in the compositions disclosed herein can have a particle size in microns or in millimeters. In still further aspects, the rubber present in the compositions disclosed herein has a particle size no smaller than about 0.00001 inches, no smaller than about 0.0001 inches, no smaller than about 0.001 inches, no smaller than about 0.01 inches, no smaller than about 0.1 inches, no smaller than about 0.15 inches, no smaller than about 0.2 inches, no smaller than about 0.25 inches, no smaller than about 0.3 inches, no smaller than about 0.35 inches, no smaller than about 0.4 inches, or no smaller than about 0.45 inches.

In some aspects, the aggregates present in the composition need to be a smaller diameter than the diameter of the nails intended for use. Without wishing to be bound by any theory, it is assumed that a small enough piece of aggregate may allow for nail deflection without detrimental effects.

In yet other aspects, the rubber can have a particle size of about 0.05 inches to about 0.45 inches, including exemplary values of about 0.1 inches, about 0.15 inches, about 0.2 inches, about 0.25 inches, about 0.3 inches, about 0.35 inches, about 0.4 inches, and about 0.45 inches. In yet other aspects, the rubber can have a particle size up to about 1 inch, including exemplary values of about 0.1 inches, about 0.15 inches, about 0.2 inches, about 0.25 inches, about 0.3 inches, about 0.35 inches, about 0.4 inches, about 0.45 inches, about 0.5 inches, about 0.55 inches, about 0.6 inches, about 0.65 inches, about 0.7 inches, about 0.75 inches, about 0.8 inches, about 0.85 inches, about 0.9 inches, and about 0.95 inches.

In still further aspects, the rubber comprises natural rubber, natural polyisoprene, synthetic polyisoprene, styrene-butadiene rubber, butadiene rubber, butyl rubber, halogenated butyl rubber, nitrile rubber, hydrogenated nitrile rubber, ethylene propylene diene rubber, ethylene propylene rubber, chloroprene, polychloroprene, neoprene, silicone rubber, fluorosilicone rubber, fluoroelastomers, perfluloroelasomers, polyether block amides, polysulfide rubber, ethylene-vinyl acetate, chlorusulfonated polyethylene, epichlorhydrin rubber, inorganic rubber, or any combination thereof. In yet still further aspects, the rubber can be substituted by an elastomer such as thermoplastic elastomers, proteins resilin, elastin, elastolefin, poly(dichlorophosphazene), and the like, and any combination thereof.

In still further aspects, the concrete composition disclosed herein can comprise water in an amount of about 20 wt % to about 40 wt %, including exemplary values of about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, and about 39 wt %, based on the water-to-cement-ratio.

In still further aspects, the concrete composition disclosed herein can comprise one or more fillers, plasticizers, water-reducing agents, pumping agents, air entrainers, set retarders, fire retardants, water repellants, defoamers, antifreeze agents, expanding agents, curing agents, coloring additives, anti-dispersant agents, mold release agents, antimicrobial agents, fire-retardants, antifungal agents, insect- and animal-repellant agents, anti-corrosion additive, adhesive additives, or any combination thereof.

In some aspects, if plasticizers are present, they can be an amount of about 0.25 wt % to about 8 wt %, including exemplary values of about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, and about 7.5 wt %, based on the weight of the cement.

In such exemplary aspects, the one or more plasticizers comprise lignosulfonates, naphthalene, sulfonated naphthalene formaldehyde (SNF), melamine sulfonate-based superplasticizer, polycarboxylate ether superplasticizer (PCE), just polycarboxylate (PC), polycarboxylate superplasticizer monomer in ether mode (TPEG-HPEG) or any combination thereof.

In still further aspects, the filler can be present from greater than 0 wt % to about 70 wt %, including exemplary values of about 0.1 wt %, about 0.5 wt %, about 1 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, and about 69 wt % based on the total concrete composition.

In yet still further aspects, the filler can be present up to about 300 wt % based on the weight of the cement, including exemplary values of about 1 wt %, 10 wt %, about 20 wt %, about 50 wt %, about 100 wt %, about 120 wt %, about 150 wt %, about 170 wt %, about 200 wt %, about 220 wt %, about 250 wt %, and about 280 wt %.

In such exemplary aspects, the filler comprises one or more of calcium carbonate, flyash, pozzolanic ash, calcium carbonate, aluminum trihydrate, talc, nano-clay, barium sulfate, barite, barite glass fiber, fiberglass glass powder, glass cullet, metal powder, alumina, hydrated alumina, clay, magnesium carbonate, calcium sulfate, silica, glass, fumed silica, carbon black, graphite, cement dust, feldspar, nepheline, magnesium oxide, zinc oxide, aluminum silicate, calcium silicate, titanium dioxide, titanates, glass microspheres, chalk, calcium oxide, and any combination thereof.

In certain aspects, the cement composition can comprise reinforcing materials, such as, for example, and without limitations fiberglass. It is understood, however, that other reinforcing materials can be utilized. In some aspects, the fiberglass can be present as it, or it can also be reinforced with the polymers, such as for example, polypropylene, nylon, or a combination thereof. In still further aspects, these reinforcing materials can be present in an amount of about 0.1 wt % to about 10 wt %, including exemplary values of about 0.2 wt %, about 0.5 wt %, about 0.7 wt %, about 1 wt %, about 2 wt %, about 3 wt %, about 4 wt %, about 5 wt %, about 6 wt %, about 7 wt %, about 8 wt %, and about 9 wt %, based on the weight of the cement present in the composition.

In still further exemplary and unlimiting aspects, the water-reducing agent can be sodium lignosulfonate or calcium lignosulfonate. Water-reducing agents can also comprise hydroxycarboxylic acids, hydroxylated polymers, and the like.

In still further exemplary and unlimiting aspects, the air entrainers can comprise wood-derived acid salts, such as vinsol resins and wood rosins, and synthetic resins. It is understood that these compounds are only exemplary, and any known in the art air entrainers suitable for the desired purpose can be utilized.

In still further aspects, the cement composition disclosed herein comprises fire-retardants. In such aspects, the fire-retardant can comprise aluminum trihydrate (ATH), chlorinated tris [tris(1,3-dichloro-2-propyl)phosphate, TDCPP, and TDCIPP], Pentabromodiphenyl ether (PentaBDE) mixture [DE-71 (technical grade)], Tetrabromobisphenol A (TBBPA), Tris(2-chloroethyl) phosphate (TCEP), or any combination thereof.

### Articles

In still further aspects, disclosed herein are articles comprising the disclosed herein composition. In certain aspects, disclosed herein is an article comprising: a) a cement in an amount of about 25 wt % to about 70 wt % based on a total mass of dry material; b) a rubber in an amount of about 15 wt % to about 35 wt % on a total mass of dry material; c) fine aggregates in an amount of about 10 wt % to about 35 wt % on a total mass of dry material; and d) water in an amount of about 20 wt % to about 40 wt % on a water-to-cement ratio; wherein the concrete composition is substantially free of coarse aggregates.

In certain aspects, the article comprises a concrete, a tile, a brick, a paver, a panel, a synthetic stone, or any combination thereof. In yet still further aspects, the article is a fence post, a desk slab, a shelf, a floor slab, a roof slab, a siding slab, exterior siding, structural columns, structural beams, fence boards, garden beds, landscape timbers, stakes, trellises, guard rail posts, concrete masonry units, concrete block or cinder blocks, patching compound, cribbing, dunnage, pallets, crates, railroad ties, vaults, pipes, culverts, handrails, joists, rafters, trusses, fire retardant structural members (firewall), furniture, cabinets, deck boards, moldings, baseboards, animal pens, pavers, fence horizontal beams, fence pickets, racks, mezzanines, flooring, telephone poles, power poles, roofing tiles, sheathing, work benches, bridges, scaffolding, kitchen counters, or any combination thereof.

Any known in the art fire retardant can be used. Some of the examples can be found in U.S. Pat. Nos. 5,989,706; 5,925,457; 5,645,926; 5,603,990; 5,064,710; 4,635,025; 4,345,002; 4,339,357; 4,265,791; 4,241,145; 4,226,907; 4,221,837; 4,210,452; 4,205,022; 4,201,677; 4,201,593; 4,137,849; 4,028,333; 3,955,987 and 3,934,066. Intumescent fire retardant can include latex. Various companies, for example, the Cary Company, Addison, III., U.S.A., Kemco International Associates, St. Pete, Fla., U.S.A., and Verichem, Inc., Pittsburgh, Pa., U.S.A., market components for paints and coatings including flame retardant additives, smoke suppressant additives, and biocides. Various fire retardants are described in, e.g., U.S. Pat. Nos. 6,207,085; 5,997,758; 5,882,541; 5,626,787; 5,165,904; 4,744,965; 4,632,813; 4,595,414; 4,588,510; 4,216,261; 4,166,840; 3,969,291 and 3,513,114.

In still further aspects, the article is nailable and/or screwable and exhibits a nail and/or screw insertion shear stress of about 500 to about 1200 pounds per square inch, including exemplary values of about 550 pounds per square inch, about 600 pounds per square inch, about 650 pounds per square inch, about 700 pounds per square inch, about 750 pounds per square inch, about 800 pounds per square inch, about 850 pounds per square inch, about 900 pounds per square inch, about 950 pounds per square inch, about 1000 pounds per square inch, about 1050 pounds per square inch, about 1100 pounds per square inch, and about 1150 pounds per square inch. In still further aspects, the articles disclosed herein exhibit a nail and/or screw withdrawal or pullout stress of about 150 to about 1450 pounds per square inch, including exemplary values of about 200 pounds per square inch, about 250 pounds per square inch, about 300 pounds per square inch, about 350 pounds per square inch, about 400 pounds per square inch, about 450 pounds per square inch, about 500 pounds per square inch, about 550 pounds per square inch, about 600 pounds per square inch, about 650 pounds per square inch, about 700 pounds per square inch, about 750 pounds per square inch, about 800 pounds per square inch, about 850 pounds per square inch, about 900 pounds per square inch, about 950 pounds per square inch, about 1000 pounds per square inch, about 1050 pounds per square inch, about 1100 pounds per square inch, about 1150 pounds per square inch, about 1200 pounds per square inch, about 1250 pounds per square inch, about 1300 pounds per square inch, about 1350 pounds per square inch, and about 1400 pounds per square inch.

In still further aspects, the nail withdrawal or pullout stress is about 150 to about 500 pounds per square inch, including exemplary values of about 200 pounds per square inch, about 250 pounds per square inch, about 300 pounds per square inch, about 350 pounds per square inch, about 400 pounds per square inch, and about 450 pounds per square inch for smooth shank steel nails.

In a still further aspect, the nail withdrawal or pullout stress is about 200 to about 650 pounds per square inch, including exemplary values of about 250 pounds per square inch, about 300 pounds per square inch, about 350 pounds per square inch, about 400 pounds per square inch, about 450 pounds per square inch, about 500 pounds per square inch, about 550 pounds per square inch, and about 600 pounds per square inch, for ring shank steel nails.

In a still further aspect, the screw withdrawal or pullout stress is about 400 to about 1450 pounds per square inch, including exemplary values of about 450 pounds per square inch, about 500 pounds per square inch, about 550 pounds per square inch, about 600 pounds per square inch, about 650 pounds per square inch, about 700 pounds per square inch, about 750 pounds per square inch, about 800 pounds per square inch, about 850 pounds per square inch, about 900 pounds per square inch, about 950 pounds per square inch, about 1000 pounds per square inch, about 1050 pounds per square inch, about 1100 pounds per square inch, about 1150 pounds per square inch, about 1200 pounds per square inch, about 1250 pounds per square inch, about 1300 pounds per square inch, about 1350 pounds per square inch, and about 1400 pounds per square inch, for wood screws.

In still further aspects, the article is adapted to receive wood screws screwed with a hand screwdriver. In still further aspects, the article is adapted to receive nails or staples. In still further aspects, a hand hammer can be used to drive in nails. In still further aspects, any power tool adapted for driving in screws or nails, or staples can be used.

It is understood that the cement composition present in the article can comprise any of the disclosed above components. In such aspects, any disclosed above the cement, rubbers, and fine aggregates can be present in any of the disclosed amounts. In still further aspects, any of the disclosed herein additives can be added to any of the disclosed amounts.

In still further aspects, the article exhibits a tensile strength of about 40 to about 100 pounds per square inch, including exemplary values of about 45 pounds per square inch, about 50 pounds per square inch, about 55 pounds per square inch, about 60 pounds per square inch, about 65 pounds per square inch, about 70 pounds per square inch, about 75 pounds per square inch, about 80 pounds per square inch, about 85 pounds per square inch, about 90 pounds per square inch, and about 95 pounds per square inch.

In some aspects, the article exhibits an ultimate compressive strength of about 150 to about 2000 pounds per square inch, including exemplary values of about 250 pounds per square inch, about 350 pounds per square inch, about 450 pounds per square inch, about 550 pounds per square inch, about 650 pounds per square inch, about 750 pounds per square inch, about 850 pounds per square inch, about 950 pounds per square inch, about 1050 pounds per square inch, about 1150 pounds per square inch, about 1250 pounds per square inch, about 1350 pounds per square inch, about 1450 pounds per square inch, about 1550 pounds per square inch, about 1650 pounds per square inch, about 1750 pounds per square inch, about 1850 pounds per square inch, and about 1950 pounds per square inch.

In still further aspects, the article can comprise at least one concrete composition reinforcing element. In such exemplary aspects, the at least one concrete composition reinforcing element is a shear reinforcing element and/or a longitudinal reinforcing element.

In some exemplary and unlimiting aspects, the strength of the sections can be improved through the introduction of additional steel. For example, if the mix is found to be insufficient from a strength perspective, additional steel reinforcement can be utilized to improve the section properties further.

In still further aspects, the presence of reinforcement elements can allow the compartmentalization of the two components of this structural system. In such aspects, the concrete article can provide the desired mechanical strength and stiffness while also providing the withdrawal or pullout strength and a surface for nailing/screwing into.

It is understood that the concrete described herein may be reinforced by wire, rods, bars, and other materials to increase the mechanical properties of the section, including decreasing the deflection under loading.

In certain aspects, the at least one concrete composition reinforcing element comprises one or more metal wires. In still further aspects, the at least one concrete composition reinforcing element comprises steel, galvanized steel, stainless steel, adhesives, or any combination thereof.

In still further aspects, the at least one concrete composition reinforcing element can be present as a reinforcement cage.

In still further aspects, larger rubber nuggets than described above and defined as having greater average diameter than the openings in the wire mesh may be placed within the reinforcement cage, and the concrete composition disclosed herein can be poured around the larger nuggets. This may be an economical method in certain loading conditions.

In still further aspects, the article is configured to withstand a temperature of about −50° C. to about 50° C., including exemplary values of about −45° C., about −40° C., about −35° C., about −30° C., about −25° C., about −20° C., about −15° C., about −10° C., about −5° C., about −1° C., about −0.5° C., about 0° C., about 0.5° C., about 1° C., about 5° C., about 10° C., about 15° C., about 20° C., about 25° C., about 30° C., about 35° C., about 40° C., and about 45° C. It is understood, though, that the articles disclosed herein can be configured to withstand harsher weather conditions. For example, articles can withstand temperatures less than −50° C. or higher than 50° C.

In still further aspects, the article is substantially unchanged when exposed to a moisture from 0% to 100%, including exemplary values of about 0.5%, about 1%, about 10%, about 20%, about 30%, about 40%, about 50%, about 60%, about 70%, about 80%, and about 90% for at least 5 years, at least 7 years, at least 10 years, at least 20 years, at least 50 years, or even at least 200 years.

In still further aspects, the article can be substantially bacteria-resistant, fungal-resistant, insect-damage-resistant, crustaceans-resistant, or any combination thereof.

In still further aspects, the disclosed herein concrete compositions and articles can be recycled. It is understood that in such aspects, all components of the article can be recycled, including reinforcing elements.

### Methods

Also disclosed herein are methods for preparing the disclosed above compositions. In such aspects, the methods comprise a) mixing a composition comprising: i) a cement in an amount of about 25 wt % to about 70 wt % based on a total mass of dry material; ii) a rubber in an amount of about 15 wt % to about 35 wt % on a total mass of dry material; and ill) fine aggregates in an amount of about 10 wt % to about 35 wt % on a total mass of dry material to form a concrete composition; b) mixing concrete composition with water in an amount of about 20 wt % to about 40 wt % on a water-to-cement ratio to form concrete.

In certain aspects, the rubber can be soaked in water prior to mixing with fine aggregates and cement. In yet still further aspects, a portion of the rubber for the total rubber composition is soaked in water, while another portion of the rubber is used as provided without any additional treatment. In still further aspects, rubber can be treated prior to its use in the mixture.

In certain aspects, the method further comprises pouring the concrete into a mold to form an article. In some aspects, the mold can comprise at least one concrete reinforcing element.

In still further aspects, when the concrete article is formed, the poured concrete can be cured or annealed for a predetermined temperature for a predetermined time. In certain aspects, the concreated can be cured or annealed at about 50 deg. Fahrenheit (about 10° C.) to about 90 deg. Fahrenheit (about 32° C.), including exemplary values of about 55 deg. Fahrenheit (about 13° C.), about 60 deg. Fahrenheit (about 16° C.), about 65 deg. Fahrenheit (about 18° C.), about 70 deg. Fahrenheit (about 21° C.), about 75 deg. Fahrenheit (about 24° C.), about 80 deg. Fahrenheit (about 27° C.), and about 85 deg. Fahrenheit (about 29° C.) for 10-30 days. In still further aspects, the curing can comprise steam curing at atmospheric pressure, or high-pressure steam curing, which develops the concrete in as little as 3 days.

In still further aspects, in the methods disclosed, the concrete can be formed in situ, or it can be pre-cast.

In certain aspects, the method further comprises the pre-tensioning of the concrete. Pre-tensioning of concrete, for example, can be accomplished by placing reinforcing wire or reinforcing bar (rebar) inside a form. In such aspects, the reinforcement can be stressed by applying load. As a result, the reinforcement can be stretched. The concrete can then be poured around the stretched reinforcement. After curing, the reinforcement can be separated by any known in the art methods, causing the remaining reinforcement within the concrete to attempt to return to its original length. This effectively causes the concrete to become compressed by residual stresses incorporated into the structural element.

Yet, in other aspects, the method further comprises post-tensioning of the concrete. Post-tensioning of concrete could be accomplished by placing a conduit or duct within the concrete during casting. The concrete could be cast as normal, though other reinforcing wire that is not to be stressed may be included in the form. Reinforcing wire or other reinforcement could be placed inside the conduit either before pouring or after. After sufficient concrete curing, the reinforcement is stressed by applying load to the reinforcement, causing it to stretch. A securing device could be placed at the ends of the conduit, which may be supported by the poured concrete. This securing device would allow the wire to remain in a stretched position. After removing the tensioning device, the wire within the conduit attempts to return to its original length. This effectively causes the concrete to become compressed by residual stresses incorporated into the structural element. Pre-tensioning and post-tensioning of the concrete are possible in order to modify the properties of the final product by allowing for increased withdrawal or pullout strength of mechanical fasteners as well as a reduction in tensile cracking of the concrete during loading.

In still further aspects, the methods of making the concrete described herein can comprise a concrete vibrator. Alternatively, the steel formwork of the future article could be vibrated itself.

In still further aspects, the reinforcing elements such as wire and/or cage be fed through an extrusion machine. In still further aspects, an automated welding machine should be used for the manufacture of individual rebar/reinforcement wire cages.

It is understood that reinforcement (or reinforcing elements) may be manufactured by numerous methods, including automated and manual methods. For example, reinforcement may be manufactured using hand tying and hand welding methods. Manufacturing of reinforcement cages may also employ the use of jigs or other fixtures to provide consistency and speed in manufacturing. Reinforcement may be constructed using automated methods such as automatic pile cage welding machines or automatic square cage welding machines.

In still further aspects, the articles comprising the disclosed concrete can be adapted to be 3D printed. Yet in still further aspects, the methods of applying concrete to form an article can also include sprayed concrete (e.g., shotcrete), pressed concrete (e.g., paver casting methods using a pressed mold), rolled methods (e.g., used for thin concrete siding panels), etc.

In still further aspects, and as disclosed above, the concrete disclosed herein can be used as a patch. In such aspects, the methods can further comprise patching an article with the concrete.

It is understood that the concrete formed by the methods disclosed herein can be applied by any known in the art methods. For example, the method can further comprise applying the concrete pneumatically.

In still further aspects, disclosed herein are methods of driving nails into the disclosed articles. It is understood that the process of nailing can be done with a hand hammer. In yet other aspects, the nailing can be done with the use of a power tool. Yet, in still further aspects, the nailing can be done with the use of power tools.

Also disclosed herein are methods of driving screws into the disclosed articles. In such aspects, the method of screwing does not comprise forming a pilot hole in the article. However, it is understood that if desired, the pilot hole can also be formed. In still further aspects, screwing can be done with the use of a hand screw and/or power tool.

It is understood that any known in the art nails, screws, and staples can be driven into the articles disclosed herein. It is also understood that any nails, screws, and/or staples that are conventionally used for wood articles can also be used for the articles disclosed herein.

### EXAMPLES

The following examples are set forth below to illustrate the methods and results according to the disclosed subject matter. These examples are not intended to be inclusive of all aspects of the subject matter disclosed herein but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.), but some errors and deviations should be accounted for. Unless indicated otherwise, parts are parts by weight, the temperature is in ° C. or is at ambient temperature, and pressure is at or near atmospheric. There are numerous variations and combinations of reaction conditions, e.g., component concentrations, temperatures, pressures, and other reaction ranges and conditions, that can be used to optimize the product purity and yield obtained from the described process. Only reasonable and routine experimentation will be required to optimize such process conditions.

### Example 1

Typical concrete used in construction having a compressive force from 3,000 to 5,000 psi does have available fasteners that can be easily introduced into the concrete without the use of powered devices. The installation of the current concrete fasteners is not simple and requires a number of steps. For example, to insert concrete anchors, such as Tapcons, one needs to drill a hole, such as a pilot hole, into the concrete. Then, the concrete anchor must be driven in, which generally requires the use of two separate drills or bit changeouts. Alternatively, there are concrete sleeve anchors and concrete wedge anchors that also require drilling out a hole and then driving the anchors into the concrete. Other routes for installing the anchors into the concrete include the use of a drop-in anchor (having a female threaded component), the use of epoxy anchoring, or the use of a powder-actuated nail gun, which uses (typically) a 0.22 long rifle blank to drive a nail through and into the concrete using the explosive force of the detonation of the gun powder within the case. These complicated installation procedures make commonly used concrete not usable for lumber substituting applications.

The concrete compositions described herein allow the disclosed concrete (or article comprising such concrete) to be nailed or screwed as if it were wood.

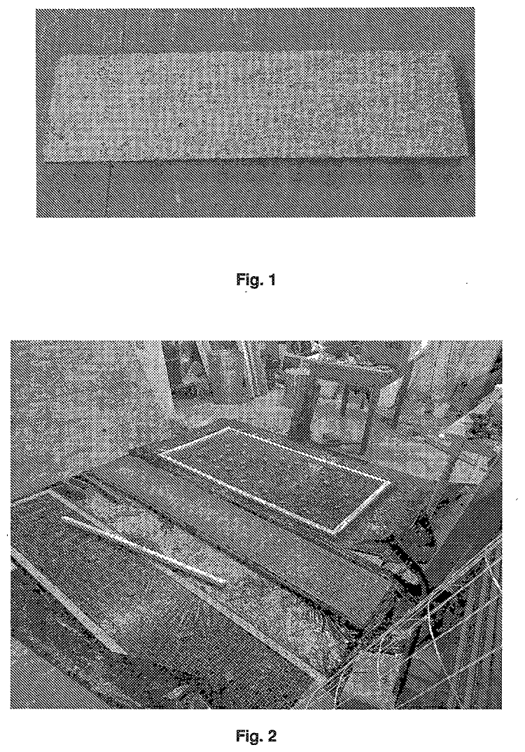

This is disclosed herein concrete, and articles comprising the same are significantly faster to install. Therefore, the economic benefit is that the material can be installed as quickly and treated nearly identically to the wood while maintaining superior weather resistance and similar cost to wood. FIG. 1 shows a sample of the concrete cast with two layers of reinforcement wire into a board.

Withdrawal (or pullout) strength has been reported before and can be calculated based on Ex. 1.

$$F = μπ DL \sqrt{{σ}_{c ‖} + {σ}_{c ⊥}} \qquad ( 1 )$$

Where F is the withdrawal (pullout) strength, μ is the frictional coefficient, D is the diameter of the nail, L is the length of the fastener into the material, σ_{c∥} is the compressive strength parallel to the grain, and σ_{c⊥} is the compressive strength perpendicular to the grain.

For convenience, the compressive strength parallel to the grain and perpendicular to the grain can be assumed to be equal in the samples as the concrete cast is more homogeneous than the wood used to develop these equations (Ex. 2).

$$F = μπ DL \sqrt{2 {σ}_{c}} \qquad ( 2 )$$

It is noted that the equation is developed as a more analytically derived equation for calculating the withdrawal (pullout) force of a fastener driven into wood. It is understood that the withdrawal (pullout) force is a function of the frictional coefficient of the material. While concrete-steel contact is commonly noted as having a coefficient of static friction of 0.6, wood-steel contact is commonly 0.4 for dry wood, and rubber is commonly stated as having a coefficient of static friction of 1.0 against steel; this means that rubber can more easily develop the necessary withdrawal (pullout) strengths without an excessively high compressive strength.

Without wishing to be bound by any theory, it is assumed that the force required to drive a nail and to withdraw a nail are intricately linked. Again, without wishing to be bound by any theory, it is assumed that this occurs due to the fact that many nails are driven and resist withdrawal (pullout) through the use of friction. This friction occurs due to the squeezing of the nail by the wood upon driving the nail. This squeezing action develops a force that also resists the insertion of a nail.

Without wishing to be bound by a theory, it was hypothesized that when a nail is driven into a material, Young's modulus of the material affects its ability to “squeeze” the nail to hold it into place. Commercially available concretes have a high Young's modulus as compared to the nail, and as a result, a little squeezing occurs.

The test pieces created for comparison to the disclosed invention were constructed using mortar mixes regularly used by bricklayers to create lower-strength concrete. It was shown that the mortar mixes did not produce any notable withdrawal or pullout strength.

As described in detail above, the disclosed concrete compositions and articles comprising the same are adapted to use with nails, staples, and screws, as these are the most common fasteners. It should also be noted that despite the focus on nailability, these other fasteners appear to commonly share use with this property. It is understood that if a material can be nailed together, it can commonly be screwed or stapled together.

Given concretes low tensile strength, a nail or other cylindrical object inserted into an undersized hole causes the development of tensile stresses in the material surrounding the hole. However, for any concrete, these tensile stresses that develop must be resolved by adding tensile reinforcement.

Interestingly, it was found that the samples produced with no fine aggregates and only portland cement and rubber did not have adequate nailability.

The specific mixtures used in this example are shown in Tables 1 and 3. Table 1 is based on volumetric measurements, while Table 3 is based on weight measurements of the ingredients. Table 2 shows the densities used for conversion.

One exemplary method is a stacked exterior mold or formwork with a ½″×½″ hardware cloth supporting reinforcing wire within the mold to create the members. On longer spans, support can be provided under the hardware cloth, a current and common manufacturing method used for other reinforced concrete.

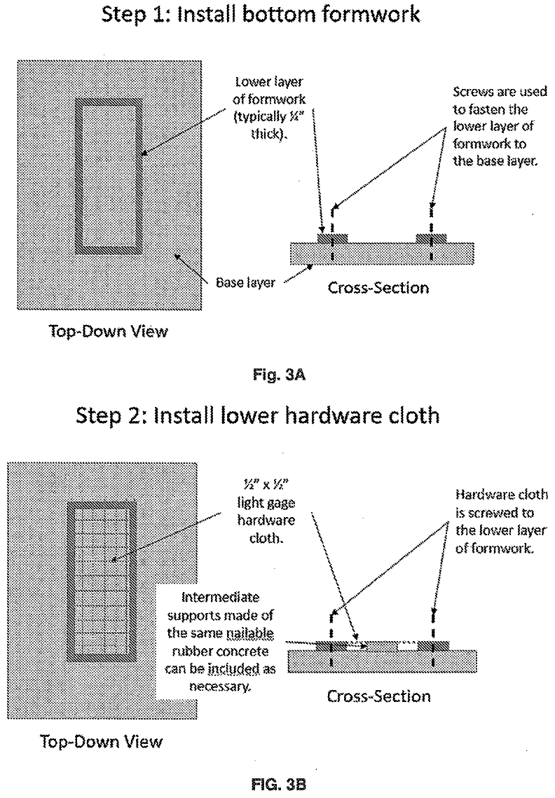

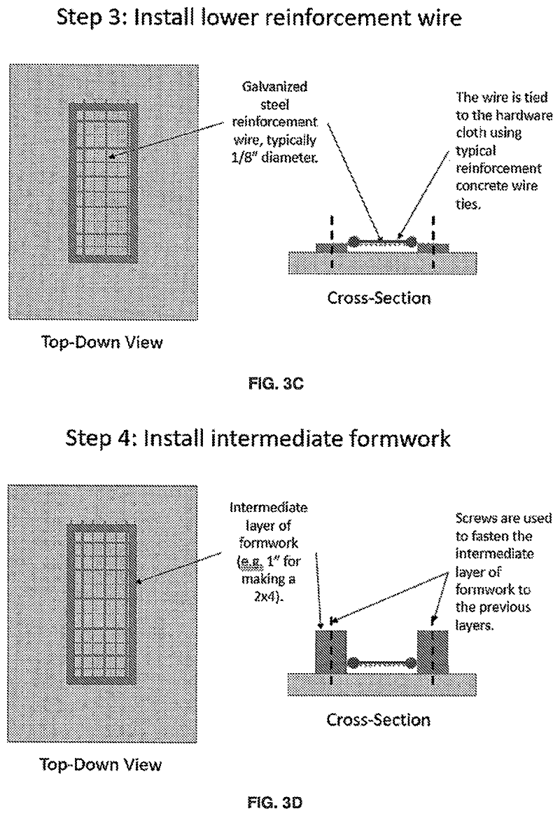

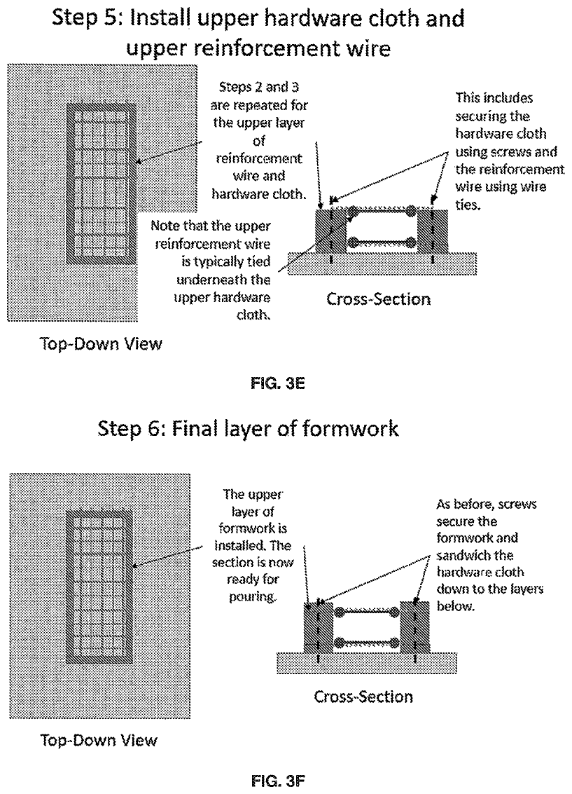

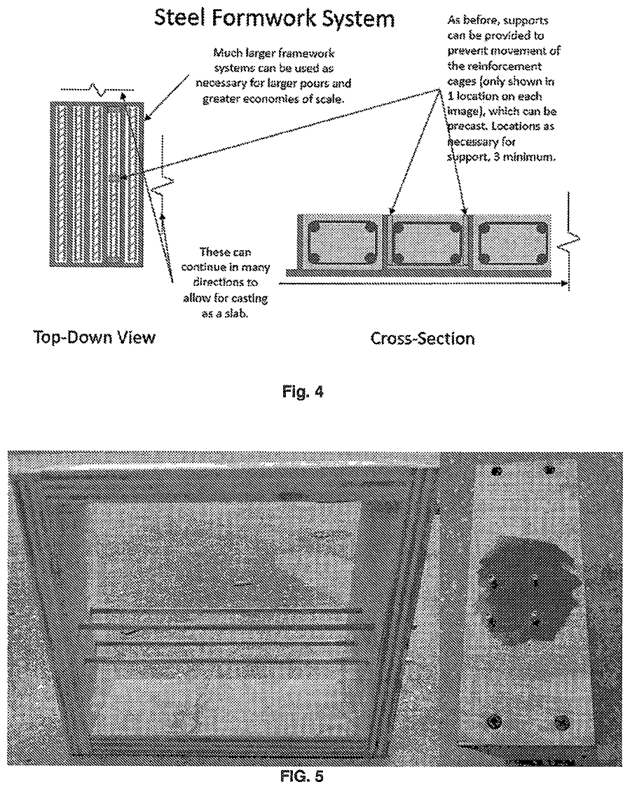

An example of the nailable rubber concrete during various stages of manufacture is shown in FIG. 2. To explain one method of manufacturing the nailable rubber concrete, a series of steps are shown in FIGS. 3A-3F. These figures show the buildup of the formwork to allow for the necessary support of the concrete during construction. A gravity pouring method that focuses on a standardized formwork made of noncorroding material. The automatically welded rebar cages are dropped into formwork and braced on all sides by previously cast pieces of nailable rubber concrete. This method requires pouring the concrete as though it were a large slab of uniform top height so that the concrete can be leveled. An example of this concept is shown in FIG. 4.

The economics of the concrete disclosed herein was calculated and is shown in Table 4. The data is compared against pressure-treated lumber prices.

TABLE 1
Exemplary mixtures on a volumetric basis and their performance

| Mix | Volumes (oz) | | | | |
|---|---|---|---|---|---|
| Sample | | Portland | Crumb | sum | |
| Name | Sand | Cement | Rubber | (oz) | Note |
| X | 143.10 | 238.50 | 429.30 | 810.90 | Appropriate |
| | | | | | Nailability |
| X-2 | 83.10 | 298.50 | 429.30 | 810.90 | Appropriate |
| | | | | | Nailability; Extra |
| | | | | | Exterior Hardness |
| S-L.1 | 663.64 | 147.47 | 0.00 | 811.11 | No Nailability; Based |
| | | | | | on 2100 psi Mortar S |
| | | | | | Mix |
| S-L.2 | 497.73 | 147.47 | 165.91 | 811.11 | No Nailability; Based |
| | | | | | on 2100 psi Mortar S |
| | | | | | Mix |
| S-L.3 | 334.13 | 148.50 | 334.13 | 816.75 | No Nailability; Based |
| | | | | | on 2100 psi Mortar S |
| | | | | | Mix |
| S-L.4 | 167.06 | 148.50 | 501.19 | 816.75 | No Nailability; Based |
| | | | | | on 2100 psi Mortar S |
| | | | | | Mix |
| S-L.5 | 0.00 | 147.47 | 663.64 | 811.11 | No Nailability; Based |
| | | | | | on 2100 psi Mortar S |
| | | | | | Mix |
| 1:9-L.1 | 730.00 | 81.11 | 0.00 | 811.11 | No Nailability |
| 1:9-L.2 | 547.50 | 81.11 | 182.50 | 811.11 | No Nailability |
| 1:9-L.3 | 365.00 | 81.11 | 365.00 | 811.11 | No Nailability |
| 1:9-L.4 | 182.50 | 81.11 | 547.50 | 811.11 | No Nailability |
| 1:9-L.5 | 0.00 | 81.11 | 730.00 | 811.11 | No Nailability |
| 1:6-L.1 | 695.14 | 115.86 | 0.00 | 811.00 | No Nailability |
| 1:6-L.2 | 521.36 | 115.86 | 173.79 | 811.00 | No Nailability |
| 1:6-L.3 | 347.57 | 115.86 | 347.57 | 811.00 | No Nailability |
| 1:6-L.4 | 173.79 | 115.86 | 521.36 | 811.00 | No Nailability |
| 1:6-L.5 | 0.00 | 115.86 | 695.14 | 811.00 | No Nailability |

TABLE 2
Densities of the primary ingredients.

| Densities | Weight (lbs) | oz | lbs/oz |
|---|---|---|---|
| Rubber | 3.144 | 128 | 0.0245625 |
| Sand | 6.568 | 64 | 0.102625 |
| Portland Cement | 6.272 | 64 | 0.098 |

TABLE 3
Exemplary mixtures on a weight basis and their performance

| Mix | Weight (lbs) | | | | |
|---|---|---|---|---|---|
| Sample | | Portland | Crumb | sum | |
| Name | Sand | Cement | Rubber | (lbs) | Note |
| X | 14.69 | 23.37 | 10.54 | 48.60 | Appropriate Nailability |
| X-2 | 8.53 | 29.25 | 10.54 | 48.33 | Appropriate |
| | | | | | Nailability; Extra |
| | | | | | Exterior Hardness |
| S-L.1 | 68.11 | 14.45 | 0.00 | 82.56 | No Nailability; Based |
| | | | | | on 2100 psi Mortar S |
| | | | | | Mix |
| S-L.2 | 51.08 | 14.45 | 4.08 | 69.61 | No Nailability; Based |
| | | | | | on 2100 psi Mortar S |
| | | | | | Mix |
| S-L.3 | 34.29 | 14.55 | 8.21 | 57.05 | No Nailability; Based |
| | | | | | on 2100 psi Mortar S |
| | | | | | Mix |
| S-L.4 | 17.14 | 14.55 | 12.31 | 44.01 | No Nailability; Based |
| | | | | | on 2100 psi Mortar S |
| | | | | | Mix |
| S-L.5 | 0.00 | 14.45 | 16.30 | 30.75 | No Nailability; Based |
| | | | | | on 2100 psi Mortar S |
| | | | | | Mix |
| 1:9-L.1 | 74.92 | 7.95 | 0.00 | 82.87 | No Nailability |
| 1:9-L.2 | 56.19 | 7.95 | 4.48 | 68.62 | No Nailability |
| 1:9-L.3 | 37.46 | 7.95 | 8.97 | 54.37 | No Nailability |
| 1:9-L.4 | 18.73 | 7.95 | 13.45 | 40.13 | No Nailability |
| 1:9-L.5 | 0.00 | 7.95 | 17.93 | 25.88 | No Nailability |
| 1:6-L.1 | 71.34 | 11.35 | 0.00 | 82.69 | No Nailability |
| 1:6-L.2 | 53.50 | 11.35 | 4.27 | 69.13 | No Nailability |
| 1:6-L.3 | 35.67 | 11.35 | 8.54 | 55.56 | No Nailability |
| 1:6-L.4 | 17.83 | 11.35 | 12.81 | 41.99 | No Nailability |
| 1:6-L.5 | 0.00 | 11.35 | 17.07 | 28.43 | No Nailability |

In certain aspects, the reinforcing element can comprise a galvanized wire. In certain aspects, the non-galvanized wire is welded to form a reinforcement. The welded wire is then galvanized to provide a non-compromised coating. If during the various manufacturing processes, the galvanized coating is damaged or removed, an additional coating can be applied in the field using various methods, such as paint or cold galvanizing compounds.

Other options can also be considered if a particular application needs maximum protection. For example, if the intended use of the article includes exposure to saltwater environments, the reinforcing wire cage can be coated with a polymer, such as epoxy. As another example, if the concrete needs to last as long as possible in exterior applications, stainless steel reinforcement can be used to limit corrosion of the reinforcement and extend the life of the product. If further protection is needed of the concrete from moisture, the concrete articles disclosed herein can be painted with the concrete paint, further preventing the moisture damage. It is also understood that the concrete articles can also be painted for decorative purposes. As discussed above, if the coating is removed or is missing due to any manufacturing process steps, an additional coating can be applied in the field using various methods, such as paint or cold galvanizing compounds.

TABLE 4
Comparison of the manufactured price of nailable
rubber concrete against pressure-treated lumber
as of Aug. 26, 2022, from Lowes.com.

| | | | |
|---|---|---|---|
| | Nailable Rubber | Retail Pressure | |
| Type and | Concrete | Treated | % in |
| Section | Manufacturing Cost | Lumber Price | savings |

Fence Post

| | | | |
|---|---|---|---|
| 3.5-4 × 6.5 | $5.79 | $9.98 | 41.9% |
| 6-7 × 8 | $15.19 | $22.99 | 33.9% |

Posts

| | | | |
|---|---|---|---|
| 4 × 4 × 8 | $7.49 | $10.98 | 31.8% |
| 4 × 4 × 16 | $14.97 | $26.38 | 43.2% |
| 6 × 6 × 8 | $16.09 | $30.18 | 46.7% |
| 6 × 6 × 16 | $32.18 | $62.98 | 48.9% |

Corral Boards

| | | | |
|---|---|---|---|
| 1 × 6 × 16 | $7.90 | $18.98 | 58.4% |

Boards

| | | | |
|---|---|---|---|
| 2 × 4 × 8 SYP | $4.01 | $7.38 | 45.6% |
| 2 × 4 × 12 SYP | $6.02 | $10.78 | 44.1% |
| 2 × 4 × 16 SYP | $8.03 | $15.68 | 48.8% |
| 2 × 6 × 8 SYP | $5.51 | $7.28 | 24.4% |
| 2 × 6 × 12 SYP | $8.26 | $10.98 | 24.8% |
| 2 × 6 × 16 SYP | $11.01 | $14.88 | 26.0% |
| 2 × 8 × 8 SYP | $6.97 | $10.38 | 32.8% |
| 2 × 8 × 12 SYP | $10.46 | $16.38 | 36.2% |
| 2 × 8 × 16 SYP | $13.94 | $19.98 | 30.2% |
| 2 × 12 × 8 SYP | $9.86 | $18.98 | 48.1% |
| 2 × 12 × 12 SYP | $14.79 | $37.98 | 61.1% |
| 2 × 12 × 16 SYP | $19.72 | $52.98 | 62.8% |

It was found that the disclosed herein nailable concrete can also be patched, if necessary, to restore the appearance after use. In such aspects, the patching can be accomplished by forming more viscous compositions. In other words, using any of the disclosed herein compositions with smaller amounts of water to obtain a paste-like consistency. This paste can be used as a patching material or to fill voids by providing a material that can be nailed through.

### Example 2

To address several issues, the section to be constructed was redesigned to determine the appropriate dimensions of the longitudinal reinforcement. In order to create a conservative design, the concrete is assumed to contribute little to the strength of the beam. Accordingly, a reference design strength must be established. The material assumed is Douglas Fir, which has a maximum stress of 5000 psi parallel to its grain and was used as a reference material.

For this reference material, the strength of such a beam was calculated as follows:

$$h = 1.625 inches$$

$$b = 1.5 inches$$

$$I = \frac{1}{12} {bh}^{3} = \frac{1}{12} ( 1.5 in ) {( 1.625 in )}^{3} = 0.563 {in}^{4}$$

$$σ = \frac{Mc}{I}$$

$$σ I = M = \frac{( 5000 psi ) ( 0.536 {in}^{4} )}{\frac{1.625 in}{2}} = 3300 lbs \cdot in$$

where h is the beam height, b is the beam width, l is the second geometric moment (moment of inertia), σ is the stress (in this case, maximum), c is the greatest distance from the geometric centroid to the beam's maximum distance (in this case, half the height), and M is the corresponding bending moment (in this case, the maximum at failure).

The maximum bending moment strength of the wood beam is then used as the reference maximum strength of the beam required for the concrete. To greatly simplify the design, the concrete is assumed to have no strength so as to make a conservative design.

The process is repeated, but this time only the steel rods at the exterior of the beam are considered. For the rod diameter, a ¼″ rod is assumed. The process of determining the second geometric moment is to use the following formula:

$${A}_{rod} = \frac{π}{4} {d}_{rod}^{2} = ( \frac{π}{4} ) {( 0.25 in )}^{2} = 0.049 {in}^{2}$$

$$d = h - 2 \cdot cover = 1.625 in - 2 ( 0.125 in ) = 1.375 in$$

$$I = {nA}_{rod} {y}^{2} = {{nA}_{rod} ( \frac{d}{2} )}^{2} = ( 4 ) ( 0.049 {in}^{2} ) {( \frac{1.375 in}{2} )}^{2} = 0.093 {in}^{4}$$

$$\frac{σ I}{C} = M = \frac{( 36000 psi ) ( 0.093 {in}^{4} )}{\frac{1.375 in}{2}} = 4800 lbs \cdot in$$

where A_{rod} is the area of the rod used, d_{rod} is the diameter of the rod used, dis the depth (which is modified by subtracting the cover of ⅛ inches for each side), y is the distance from the centroid to each rod (which is half the depth, d).

This analysis results in a beam strength, without considering any benefit from the concrete, of 4860 lbs in, which is greater than that required by the wood beam equivalent. Repeating the process, the strength using the next smaller size that is readily available, which is 3/16 inches, results in a beam bending moment strength of 2730 lbs*in.

Based on the disclosed herein analysis, it was assumed that the required rod diameter is about 3/16 or about ¼ inches. Note that threaded rods must have their effective cross-sectional area reduced to reflect the reduction in diameter for the section carrying a load.

Next, the shear reinforcement was designed. Accordingly, the method of designing the shear requires estimating the worst-case shear load. As was assumed, for the testing apparatus that the span is 6 inches, the load can be determined, approximately, using the assumed wood beam equivalent strength of:

$$M = \frac{PL}{4}$$

$$\frac{4 M}{L} = P = \frac{1.33 lbs \cdot in}{6 in} = 2200 lbs$$

$${V}_{max} = \frac{P}{2}$$

For this shear load maximum, the reinforcement can be sized by the following equation:

$$s = \frac{{A}_{v} {F}_{y} d}{{V}_{n} - {V}_{c}}$$

$$\frac{s ( {V}_{n} - {V}_{c} )}{{F}_{y} d} = {A}_{v} = \frac{π}{4} {d}_{v}^{2}$$

$${V}_{c} = 2 \sqrt{{f}_{c}^{′}} {b}_{w} d = 2 \sqrt{( 1150 psi )} ( 1.5 in ) ( 1.25 in ) = 127 lbs$$

$$\sqrt{\frac{4 s ( {V}_{n} - {V}_{c} )}{π {F}_{y} d}} = {d}_{v} = \sqrt{\frac{4 ( 0.5 in ) [ ( 642 lbs ) - ( 127 lbs ) ]}{π ( 36000 psi ) ( 1.25 in )}} = 0.085 in$$

The wire selected has a diameter of 0.080 inches. This wire was selected through additional testing to be found effective and is selected at this size to improve the economics of the concrete beams.

### Example 3

Due to the issues seen in the larger test samples, a new manufacturing method had to be developed. The new methods utilize a holding jig. An exemplary holding jig is shown in FIG. 5 below.

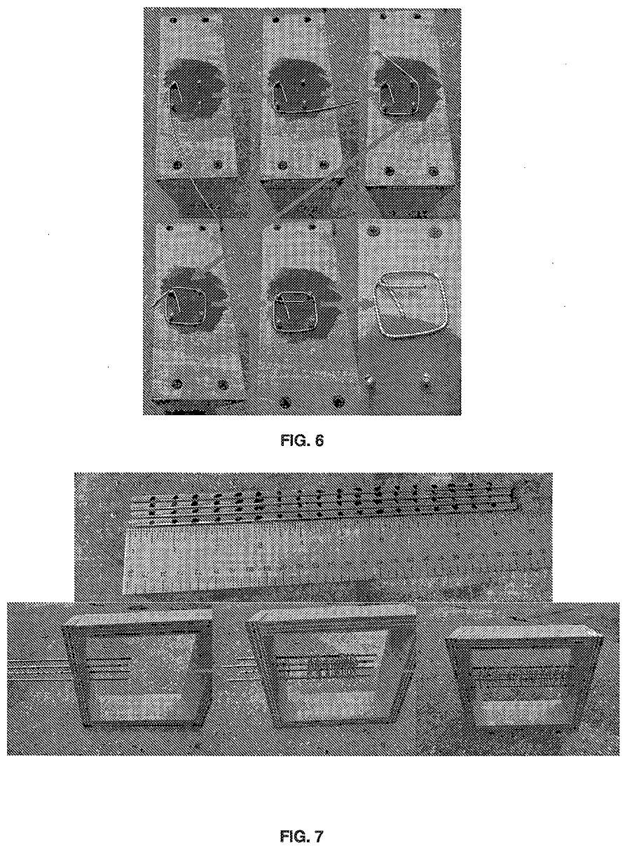

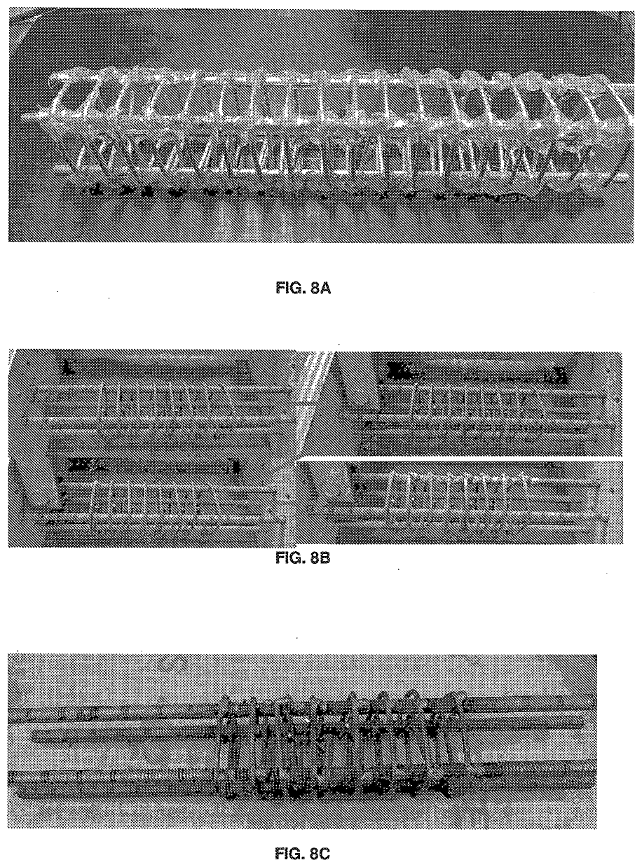

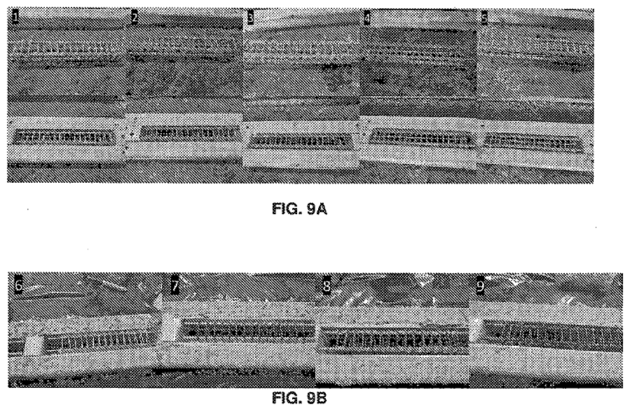

The wires were bent into shear reinforcement (often called ties). This process is shown in FIG. 6. A wire (0.080″ diameter) with properties shown in Table 5 was bent into a shear reinforcement/tie shape.

It is understood that the stirrup cage obtained according to the process shown in FIG. 6 is only exemplary, and more or less bending can be obtained as needed.

Then the longitudinal rods are marked at the tie spacings required (previously assumed spacing is about 0.5 inches). After marking, the longitudinal wires are fed through the jig while the ties are slipped over the ends. Once all ties are in place, the longitudinal reinforcement has pushed the rest of the way through the jig. These steps are shown in FIG. 7.

Additional examples of various reinforcements and process steps of making the same are shown in FIGS. 8A-8C.

TABLE 5
The properties of the shear reinforcement wire.

| Property | Value | |
|---|---|---|
| Material | Low-Carbon Steel | |
| Low-Carbon Steel Grade | 1006-1008 | |
| Shape | Wire | |
| Shape Type | Wire | |
| Diameter | 0.080″ | |
| Diameter Tolerance | −0.003″ to 0.003″ | |
| Tolerance Rating | Standard | |
| Length | 290 | ft. |
| Yield Strength | Not Rated | |
| Fabrication | Cold Drawn | |
| Heat Treatment | Annealed (Softened) | |
| Hardness | Not Rated | |
| Hardness Rating | Not Rated | |
| Maximum Hardness After | Not Rated | |
| Heat Treatment | | |
| Heat Treatable | | |
| Yield Strength | Yes | |
| Color | 70,000 | psi |
| Appearance | Dark Gray | |
| Min. Temperature | Matte | |
| Maximum Temperature | Not Rated | |
| Specifications Met | 300° | F. |
| Straightness Tolerance | ASTM A853 | |
| Elongation | Not Rated | |
| Warning Message | Not Rated | |
| Net Weight | Physical and mechanical properties are | |
| | not guaranteed. They are intended only | |
| | as a basis for comparison and not for | |
| | design purposes. | |
| Type | 5 | lbs. |

| | |
|---|---|
| Additional Specifications | Spool |
| | SDS |
| RoHS | Wire Gauge Conversion Chart |
| REACH | RoHS 3 (2015/863/EU) Compliant |
| DFARS | Not Compliant |
| Country of Origin | Specialty Metals COTS-Exempt |
| USMCA Qualifying | United States |
| Schedule B | No |
| ECCN | 721710.151 |
| URL | EAR99 |

### Example 4

The beams shown in Table 7 were tested. An MTS 858 Universal Testing Machine was used for tests.

The maximum loads are shown in Table 6. Concrete Mixture X-2 is shown in Tables 1-3.

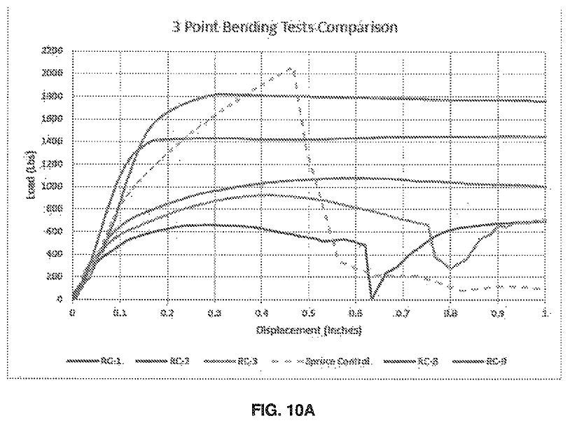

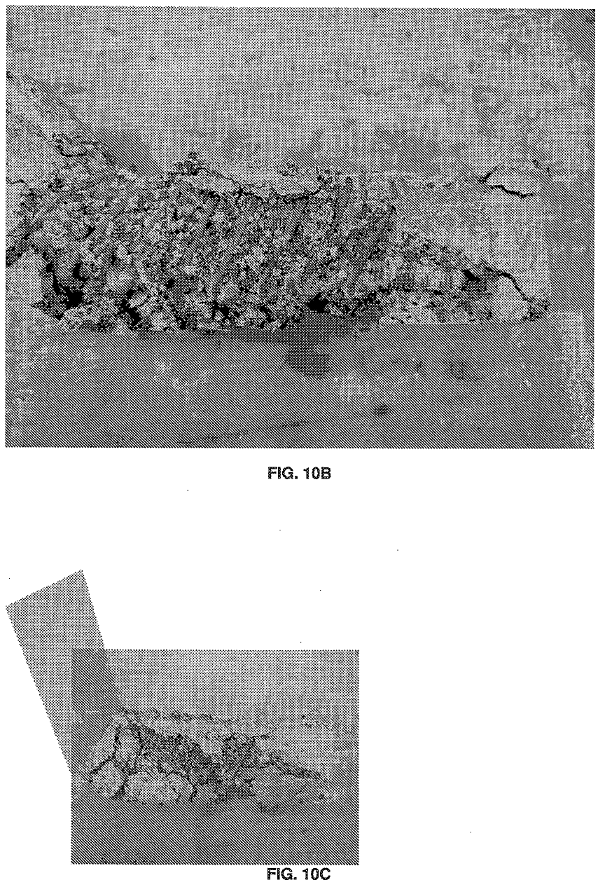

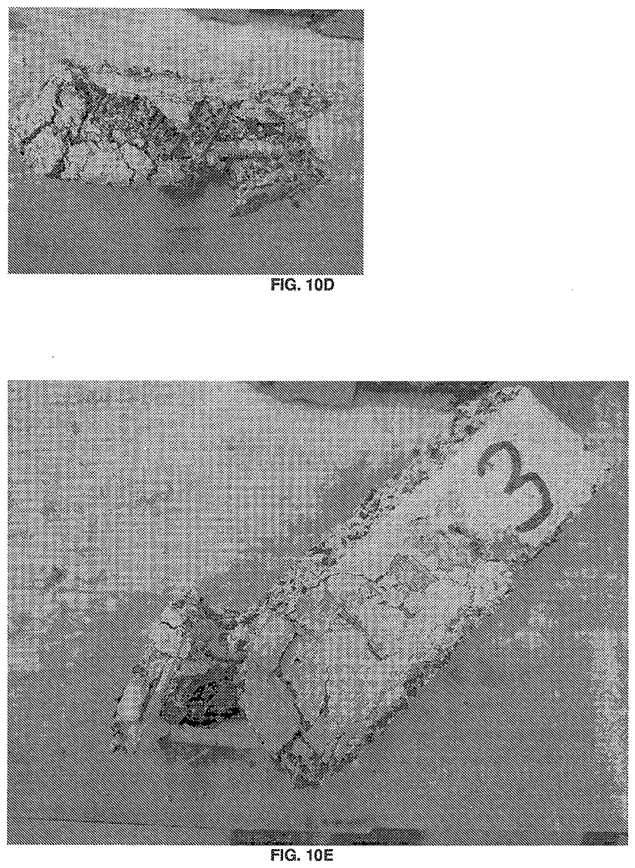

It was observed that beams failed very prematurely. In particular, beyond some additional strength development due to curing, RC-3, with the longest cure time, failed at a lower maximum value. Results for RC-3 are shown in FIG. 10E. It can be seen that the shear reinforcement slid along the length of the longitudinal reinforcement. These are indicated by the red lines, which show the location of the nearest shear reinforcement, while the red arrow indicates the location of where a shear reinforcement tie is supposed to be located currently.

TABLE 6
The measured maximum loads.

| Sample | Maximum Load, lbs |
|---|---|
| RC-1 | 711 |
| RC-2 | 1078 |
| RC-3 | 928 |
| Spruce Control | 2057 |

### Example 5

In this example, the use of threaded rods in place of smooth rods was tested to evaluate the beam performance. Reinforcement bar (rebar) used in concrete construction is designed specifically to allow for a mechanical interlocking of the concrete to the steel. To accomplish this, rebar includes ridges. However, threaded rods are more prevalent in smaller diameters than the typical minimum rebar size of #3 (or approx. ⅜″ diameter) and are assumed to have a similar interlocking ability as with rebar in concrete. To test this theory, sample RC-8 was fabricated. RC-8 includes threaded rods in place of smooth rods while continuing to use hot melt adhesive for a fixture of the shear reinforcement.

TABLE 7

| | Tie | Shear | | Longitudinal | | |
|---|---|---|---|---|---|---|
| | Diameter | Reinforcement | Attachment | Diameter | Longitudinal | Longitudinal |
| Sample | (in) | Galvanized | Method | (in) | Threaded? | Galvanized? |
| 1 | 0.08 | Yes | Hot Melt | 0.1875 | No | Yes |
| | | | Adhesive | | | |
| 2 | 0.08 | Yes | Hot Melt | 0.1875 | No | Yes |
| | | | Adhesive | | | |
| 3 | 0.08 | Yes | Hot Melt | 0.1875 | No | No (Sand |
| | | | Adhesive | | | Blasted) |
| 4 | 0.08 | Yes | Hot Melt | 0.1875 | No | Yes |
| | | | Adhesive | | | |
| 5 | 0.08 | Yes | Hot Melt | 0.1875 | No | Yes |
| | | | Adhesive | | | |
| 6 | 0.08 | Yes | Hot Melt | 0.1875 | No | Yes |
| | | | Adhesive | | | |
| 7 | 0.08 | No | Hot Melt | 0.25 | No | Yes |
| | | | Adhesive | | | |
| 8 | 0.08 | No | Hot Melt | 0.25 | Yes | No (Acid |
| | | | Adhesive | | | Bath) |
| 9 | 0.08 | No | Welded | 0.25 | Yes | No (Acid |
| | | | | | | Bath) |

| | | Concrete | | Curing | |
|---|---|---|---|---|---|
| | Casting | Mix | Testing | Time | Additional |
| Sample | Date | Used | Date | (days) | Notes |
| 1 | Nov. 2, 2022 | X-2 | Nov. 7, 2022 | 5 | Tested Early |
| | | | | | (5 days) |
| 2 | Nov. 2, 2022 | X-2 | Nov. 14, 2022 | 12 | |
| 3 | Nov. 2, 2022 | X-2 | Nov. 30, 2022 | 28 | Sand Blasted |
| 4 | Nov. 2, 2022 | X-2 | Nov. 30, 2022 | 28 | Extra Longitudinal |
| | | | | | (0.08″ diameter) |
| | | | | | for nail support, |
| | | | | | maintains ½″ |
| | | | | | gaps |
| 5 | Nov. 2, 2022 | X-2 | Nov. 30, 2022 | 28 | Extra Longitudinal |
| | | | | | (0.08″ diameter) |
| | | | | | for nail support, |
| | | | | | maintains ½″ |
| | | | | | gaps |
| 6 | Nov. 10, 2022 | X-2 | Not Tested | N/A | Used only for |
| | | | | | withdrawal |
| | | | | | (pullout) tests |
| 7 | Nov. 10, 2022 | X-2 | Not Tested | N/A | Used only for |
| | | | | | withdrawal |
| | | | | | (pullout) tests |
| 8 | Nov. 10, 2022 | X-2 | Nov. 14, 2022 | 4 | |
| 9 | Nov. 10, 2022 | X-2 | Nov. 14, 2022 | 4 | |

The reason assumed for the premature failure is the shifting of the shear reinforcement along the length of the longitudinal threaded rods. That effect can be seen in FIGS. 10C-10D.

### Example 6

The tests described herein were repeated in this example. As the threaded rod had increased the strength of the beams, the sliding of the longitudinal bars was still observed in the failed samples. Accordingly, beam RC-9 was tested, which included both threaded rods and welded fixture (FIG. 10A). Table 8 summarizes the tests. FIG. 10B shows the failed RC-9 beam.

TABLE 8
The maximum loads from FIG. 10A

| Sample | Maximum Load |
|---|---|
| RC-1 | 711 |
| RC-2 | 1078 |
| RC-3 | 928 |
| RC-8 | 1453 |
| RC-9 | 1821 |
| Spruce Control | 2057 |

It can also be seen from FIG. 10B that the nailable rubber concrete beams have a tendency to have a much lower deflection per load when using threaded rods for longitudinal reinforcement and when compared to the wood control beams. The deflection to span, assuming an allowable load of 1040 lbs, results in RC-9 having a deflection of 0.113 inches (L/53) while RC-8 has a deflection of 0.093 inches (L/65). The wood control had a deflection of 0.138 inches (L/43).

### Example 7

Regarding fasteners, those that are used for wood are most commonly nails and screws with some use of through bolts. There exist many different types of nails, however, those most commonly used in the construction industry are smooth-shank and ring-shank nails.

Smooth-shank nails have a smooth surface on their exterior. Ring-shank nails are an improvement that introduces a series of annular ridges along the length of the nail; these ridges allow the nail to mechanically interlock with the wood into which it is driven. These ridges greatly increase the withdrawal or pullout strength of nails driven into wood, as seen in the control experiments.

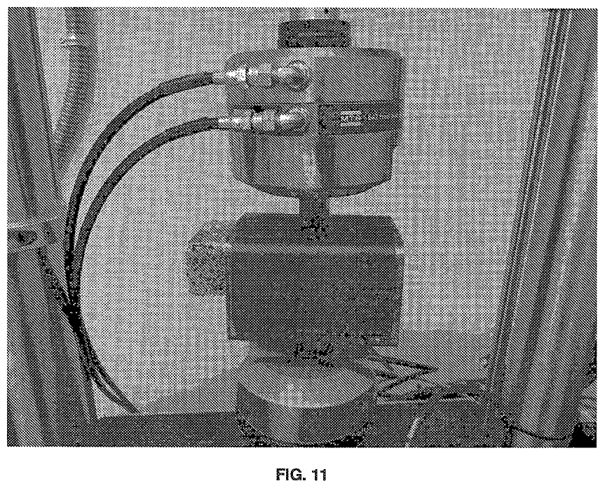

In this example, similarly to the bending moment tests, an MTS 858 system was used. A testing system was constructed. A section of hollow, square, structural steel was purchased to simplify construction. The section shape was 4×4×¼ (4 inches×4 inches exterior dimensions with a quarter-inch thickness). A slot was milled into the shape. (FIG. 11) Two withdrawal (pullout) testers were constructed, each designed for a different fastener width.

A sample is placed inside the device with a nail or screw protruding. The head is slipped into the device shown in FIG. 11 so that the MTS 858 can withdraw the fastener.

The following fastener was tested: Smooth Shank Nail Metabo HPT 2⅜″×0.113″ Plastic Strip, Full Round Head, Bright, Non-Coated, Smooth Shank; Ring Shank Nail Metabo HPT 2⅜″×0.113″ Plastic Strip, Full Round Head, Hot-Dipped Galvanized, Ring Shank; Wood Screw; Grip-Rite Primeguard Plus, Exterior Screws, 4″×10.

The nails were driven using a Metabo Cordless Strip Nailer. In order to drive the nail consistently to the same depth, the Metabo Cordless Strip Nailer was set to its minimum driving depth, and a ½″ thick strip of wood was held against the sample to produce the minimum necessary protrusion of approximately ¾″. A Bostitch F21PL, a pneumatic framing nailer, has also been successfully used with the material, though not in these experiments. Nails were driven, in one experiment, using a Vaughn 23 oz. framing hammer. Screws were installed using a Makita XDT11 Cordless Impact Driver.

Table 9 shows the testing parameters of the different NRC withdrawal samples. Note that NRC (or RC) samples referenced here correlate with those with the NRC samples shown in Table 7.

The test results are shown in FIGS. 12A-12C. Table 10 summarizes the data collected, including the maximum loads for each graph.

As can be seen in Table 10, some of the nails were not installed as desired. This occurred while the tests were being conducted, minor changes provided higher strengths as the tests proceeded. For example, if the nails are driven toward one side of the width of the sample, the strength would lower substantially.

It was found that adding an additional longitudinal reinforcement (e.g., see RC-4 and RC-5 in Table 7) made no difference.

Accordingly, it is thought that the strength of the NRC derives not from smaller reinforcement but from the larger, longitudinal reinforcement preventing the concrete from cracking from the nail being inserted. Without wishing to be bound by any theory, it is hypothesized that the nail displaces the NRC transversely, causing cracking. Larger longitudinal reinforcement, in particular when it is further from the nail insertion point, can help prevent this cracking and increase the sample's withdrawal (pullout) strength.

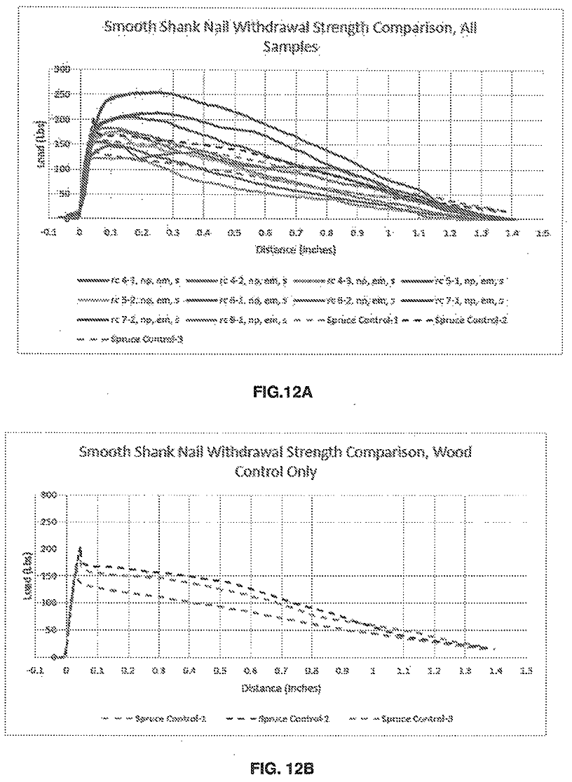

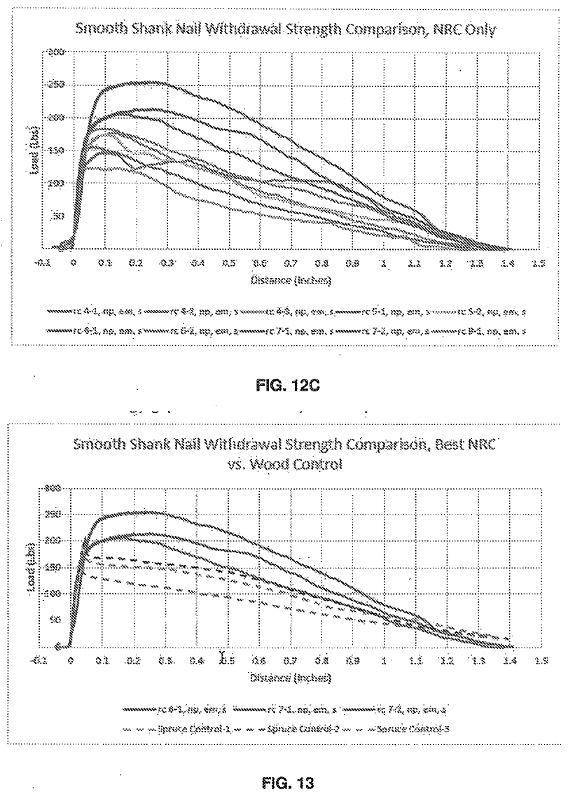

Under these assumptions, the exemplary NRC samples are shown in FIG. 13. Table 11 compares these tests.

TABLE 9

| RC | Test | Number | Concrete | Casting | Testing | Curing Time, |
|---|---|---|---|---|---|---|
| Sample | Type | of Tests | Mix | Date | Date | days |
| 4 | Smooth Shank | 3 | X-2 | Nov. 2, 2022 | Dec. 7, 2022 | 35 |
| | Ring Shank | 3 | X-2 | Nov. 2, 2022 | Nov. 30, 2022 | 28 |
| | Screw | 2 | X-2 | Nov. 2, 2022 | Dec. 9, 2022 | 37 |
| 5 | Smooth Shank | 2 | X-2 | Nov. 2, 2022 | Dec. 7, 2022 | 35 |
| | Ring Shank | 2 | X-2 | Nov. 2, 2022 | Nov. 30, 2022 | 28 |
| | Screw | 1 | X-2 | Nov. 2, 2022 | Dec. 9, 2022 | 37 |
| 6 | Smooth Shank | 2 | X-2 | Nov. 10, 2022 | Dec. 7, 2022 | 27 |
| | Ring Shank | 0 | X-2 | Nov. 10, 2022 | Nov. 30, 2022 | 22 |
| | Screw | 3 | X-2 | Nov. 10, 2022 | Dec. 9, 2022 | 29 |
| 7 | Smooth Shank | 2 | X-2 | Nov. 10, 2022 | Dec. 7, 2022 | 27 |
| | Ring Shank | 0 | X-2 | Nov. 10, 2022 | Nov. 30, 2022 | 20 |
| | Screw | 1 | X-2 | Nov. 10, 2022 | Dec. 9, 2022 | 29 |
| 9 | Smooth Shank | 1 | X-2 | Nov. 10, 2022 | Dec. 7, 2022 | 27 |
| | Ring Shank | 1 | X-2 | Nov. 10, 2022 | Nov. 30, 2022 | 20 |
| | Screw | 1 | X-2 | Nov. 10, 2022 | Dec. 9, 2022 | 29 |

TABLE 10
A summary table of the smooth shank
nail and withdrawal (pullout) tests.

| | Withdrawal | |
|---|---|---|
| Testing | (Pullout) Max. | |
| Condition | Load (Lbs) | Notes |
| rc 4-1, np, em, s | 155 | Off-center; see section arrangement |
| rc 4-2, np, em, s | 177 | Off-center; see section arrangement |
| rc 4-3, np, em, s | 123 | Off-center; see section arrangement |
| rc 5-1, np, em, s | 146 | Off-center; see section arrangement |
| rc 5-2, np, em, s | 174 | Off-center; see section arrangement |
| rc 6-1, np, em, s | 206 | |
| rc 6-2, np, em, s | 149 | Deflected/misaligned |
| rc 7-1, np, em, s | 215 | |
| rc 7-2, np, em, s | 256 | |
| rc 9-1, np, em, s | 184 | End of section; limited shear reinforc. |
| maximum | 256 | |
| average | 178 | |
| Spruce Control-1 | 196 | |
| Spruce Control-2 | 205 | |
| Spruce Control-3 | 171 | Deflected/misaligned |
| maximum | 205 | |
| average | 190 | |

TABLE 11

| Testing Condition | Withdrawal (Pullout) Maximum Load (lbs) |
|---|---|
| rc 6-1, np, em, s | 206 |
| rc 7-1, np, em, s | 215 |
| rc 7-2, np, em, s | 256 |
| maximum | 256 |
| average | 226 |
| Spruce Control-1 | 196 |
| Spruce Control-2 | 205 |
| maximum | 205 |
| average | 200 |

### Example 8

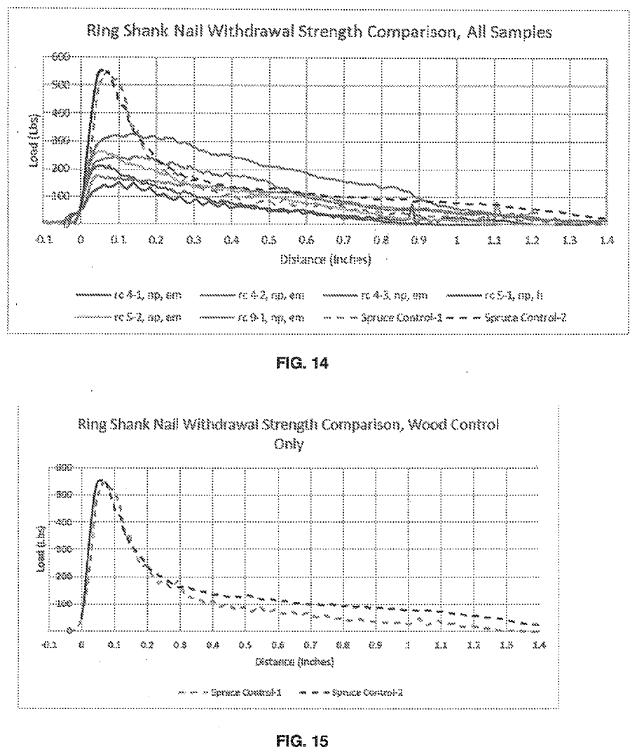

In this example, testing of nail withdrawal (pullout) was conducted with ring shank nails, and results are shown in FIG. 14. Table 12 shows the maximum loads from the graphs shown in FIG. 14. Note that these maximum values are lower than that of the wood control sections.

FIG. 15 shows the wood control withdrawal (pullout) strength of the ring shank nails used.

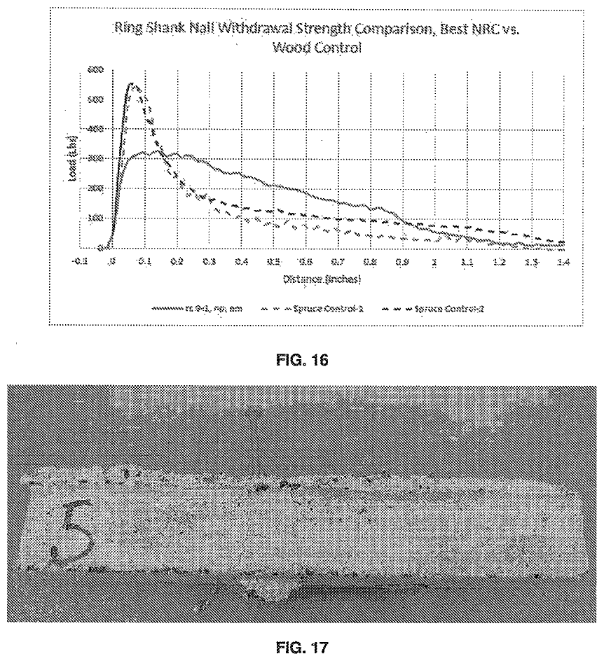

FIG. 16 and Table 13 show the exemplary samples for the wood control and NRC samples for ring shank nail withdrawal. It is thought that the ring shank nail withdrawal (pullout) can be developed further to maintain this high withdrawal (pullout) strength, particularly if the nails could continue to be driven into ideal locations.

TABLE 12

| Testing Condition | Withdrawal (Pullout) Maximum Load (lbs) |
|---|---|
| rc 4-1, np, em | 212 |
| rc 4-2, np, em | 247 |
| rc 4-3, np, em, | 175 |
| rc 5-1, np, em | 150 |
| rc 5-2, np, em | 264 |
| rc 9-1, np, em, | 326 |
| maximum | 326 |
| average | 229 |
| Spruce Control-1 | 547 |
| Spruce Control-2 | 555 |
| maximum | 555 |
| average | 551 |

TABLE 13

| Testing Condition | Withdrawal (Pullout) Maximum Load (lbs) |
|---|---|
| rc 9-1, np, em, | 326 |
| Spruce Control-1 | 547 |
| Spruce Control-2 | 555 |

### Example 9

The screws selected for testing were standard wood screws. The screws used were much longer than the samples. The longer screws were chosen to reduce the complexity of driving the screws to a specific depth. An example of a screw driven into a sample is shown in FIG. 17.

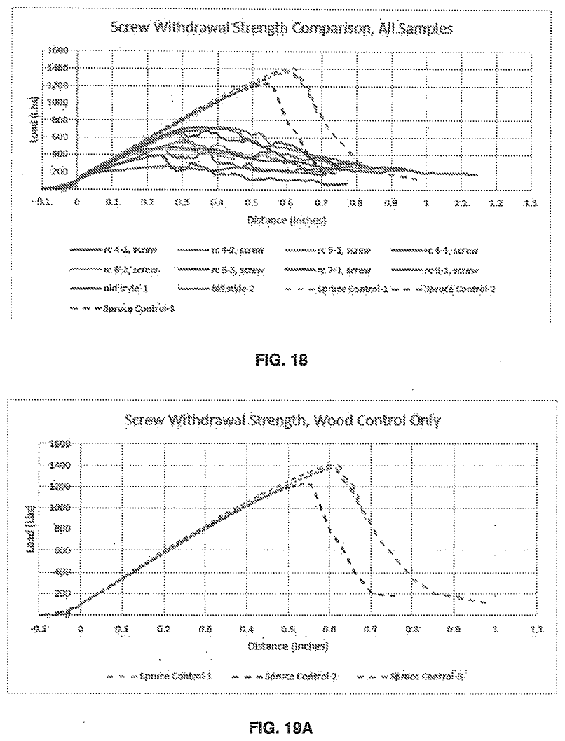

FIG. 18 shows the results of screw withdrawal (pullout) with shifting of the data. Table 14 shows the results from these figures.

The reference to old-style beams in Table 14 describes the older samples that were available prior to the change in the design of the beams used for testing. These beams were kept around and tested and had approximate dimensions of 1.625″×4″. Screws were driven into the 4″ wide side to allow for approximately the same 1.625″ embedment used in other samples.

FIG. 19A shows the results for just the wood control samples. FIG. 19B shows the exemplary NRC results compared to the wood control samples. As with other testing groups, the results for the NRC improved as the testing continued, and the installation procedure for the fasteners had improved as the tests progressed. For example, the rc 9-1, old style-1, and old style-2 were the last tests conducted.

TABLE 14

| | Withdrawal | |
|---|---|---|
| Testing | (Pullout) Max. | |
| Condition | Load (Lbs) | Notes |
| rc 4-1, screw | 485 | |
| rc 4-2, screw | 558 | |
| rc 5-1, screw | 646 | |
| rc 6-1, screw | 485 | |
| rc 6-2, screw | 466 | |
| rc 6-3, screw | 388 | |
| rc 7-1, screw | 266 | First Test |
| rc 9-1, screw | 690 | Proper compression of the Screw |
| Old style-1 | 726 | Proper compression of the Screw |
| Old style -2 | 725 | Proper compression of the Screw |
| maximum | 726 | |
| average | 544 | |
| Spruce Control-1 | 1410 | |
| Spruce Control-2 | 1231 | |
| Spruce Control-3 | 1375 | |
| maximum | 1410 | |
| average | 1339 | |

Table 15 shows the exemplary NRC samples as compared to wood. These samples had limited cracking on the surface after screw installation. One of the improvements found was that the screws when being driven must be pressed hard into the surface. This is a common practice in the industry, so it is not abnormal to do this. It appears to be required as the screws have a tendency to want to only damage the surface of the concrete before they begin to fasten properly. That is, until the harder coating on the concrete is sufficiently penetrated, the screw creates a cone of damaged concrete, but once the flights of the screw engage properly, the screw behaves properly.

Table 15. The reduced table shows the test results for the exemplary NRC compared to the wood control for the screw withdrawal (pullout) tests.

TABLE 15

| Testing Condition | Withdrawal (Pullout) Maximum Load (lbs) |
|---|---|
| rc 9-1, screw | 690 |
| Old style-1 | 726 |
| Old style-2 | 725 |
| maximum | 726 |
| average | 714 |
| Spruce Control-1 | 1410 |
| Spruce Control-2 | 1231 |
| Spruce Control-3 | 1375 |
| maximum | 1410 |
| average | 1339 |

### Example 10

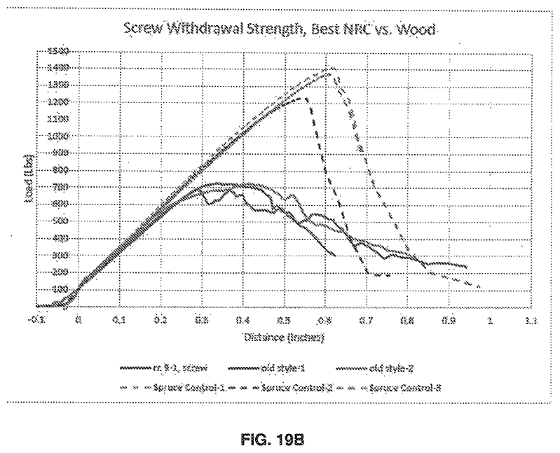

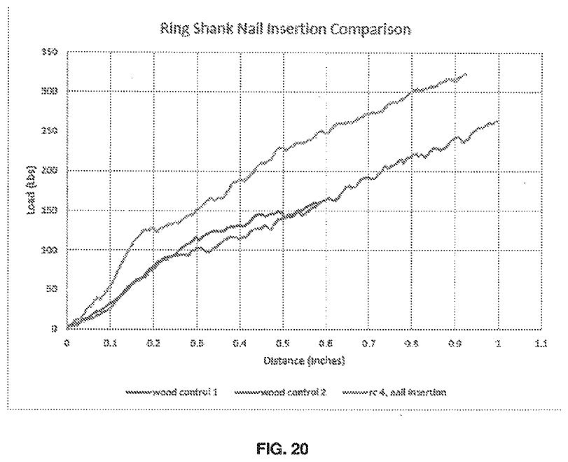

Another concern is whether the nails can be inserted into a material. This is a key feature of the NRC concept; despite being composed of concrete, the material can be hammered by hand. In order to test this concept, the MTS 858 was set up using the nail withdrawal fixture. A disk magnet was attached to the slot to discourage the slipping of the nail. The nails used are the ring shank nails previously referenced. The device was run in compression mode to cause the nail to be inserted into the material instead of being withdrawn. The results of the tests are shown in FIG. 20 and Table 16.

TABLE 16
The maximum forces from the graph shown in FIG. 20 are shown.

| Testing Condition | Insertion Load (lbs) |
|---|---|
| rc 4, nail insertion | 324 |
| Wood control 1 | 162 |
| Wood control 2 | 264 |

Table 16 shows the maximum force of insertion for two control tests and one NRC test. The load required for the insertion of a ring shank nail into the NRC was 324 lbs at the maximum depth of approximately 1 inch. However, this result is likely limited as the MTS 858 did not fully insert the nail to the maximum depth of the test of 1 inch. Extrapolating data, it could be suggested that the insertion force required for the NRC with mix X2 would be approximately 350 lbs. In that case, the increase in insertion force would be a 33% increase over wood.

It should be noted that significantly larger samples of NRC with mix X2 have been produced and have been easily nailed using a hammer and nailed by hand.

Interestingly, results from FIG. 20 show the steep curve at the onset of load for the NRC sample. Interestingly, the NRC has a harder exterior that must be penetrated before the nail can be driven at a more regular force. However, the advantage of this condition is that the X2 mix for the NRC allows for a harder, longer-lasting surface that is more akin to traditional concrete on the exterior. This can allow NRCs disclosed herein to last substantially longer from an abrasion perspective beyond what wood is capable of.

### Example 11

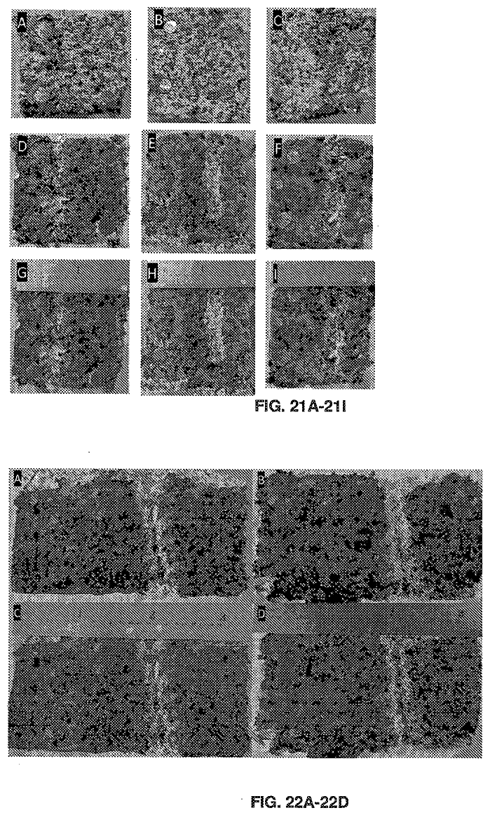

In order to understand how the NRC is performing, cavities were cut in the concrete from different tests (FIGS. 21A-221). In these figures, a smooth shank, ring shank, and screw fastener was embedded into the concrete and extracted from the material. Then, an abrasive saw was used to cut the material. A second example is shown for the old-style X2 NRC samples (these are older 1.625″×4″ samples). FIGS. 22A-22D shows the extraction cavities for a smooth shank nail (left) (FIGS. 22A and 22C) and ring shank nail (right) (FIGS. 22B and 22D). The ring shank creates a larger cavity.

Performing analysis, it can be assumed that the nail pulls along the surface area of the nail. In the case of the ring shank nails, the additional surface area is engaged by the annular rings, effectively increasing the diameter of the analysis section. Accordingly, the shear force for the samples shown in FIG. 22A-22D suggests that the strength of the NRC in this application is:

$${SA}_{cavity} = π {d}_{cavity} {h}_{embedment}$$

$${τ}_{withdrawl , failure} = \frac{{F}_{withdrawl , failure}}{{SA}_{cavity}} = \frac{{F}_{withdrawl , failure}}{π {d}_{cavity} {h}_{embedment} )}$$

where SA_{cavity} is the surface area of the nail within the material; d_{cavity} is the diameter of the shank; h_{embedment} is the embedment of the fastener into the material; T_{withdrawal,failure} is the failure shear of the interface; and F_{withdrawal,failure} is the failure load.

The resulting calculations for the best average loads of the three fastener types, an embedment distance of 1.625 inches (the height of the test beams), and a failure cavity of 0.125″ for the smooth shank, 0.1875″ for the ring shank, and 0.375″ for the screws, the resulting calculations are:

$$Smooth shank :$$

$${τ}_{withdrawl , failure} = \frac{226 lbs}{π ( 0.125 in ) ( 1.625 in )} = 354 psi$$

$$Ring Shank :$$

$${τ}_{withdrawl , failure} = \frac{326 lbs}{π ( 0.1875 in ) ( 1.625 in )} = 340 psi$$

$$Screw :$$

$${τ}_{withdrawl , failure} = \frac{714 bs}{π ( 0.375 in ) ( 1.625 in )} = 373 psi$$

So, looking at the results of the calculations, they reasonably indicate that the shear strength of the concrete in a fastener-type application, which is likely the failure mode indicated, is approximately 356 psi. This value indicates that the engagement of the fastener in the concrete directly correlates with an increase in strength.

### Example 12

The NRC appears to have some unique aspects in how it functions compared to wood. The NRC is an intended alternative to wood and offers advantages in potential applications.

To simplify the summary of the disclosure, Table 17 was developed.

It was found that while the NRC performed with a lower strength than the wood control sample, it, however, provided a superior ductile failure mode. Accounting for safety factors, the wood would have an allowable bending moment of 1.53 kip-in, while the NRC would have 1.63 kip-in. Another significant advantage is the reduction in deflection, which is commonly an issue with structures of all types and may control design in some applications. The resulting deflection for the span and allowable load of 1040 lbs, the deflection equivalent for the NRC, was at full cure L/65, while the wood would have L/43.

It was further found that smooth shank nails, the concrete disclosed herein, perform superiorly. The NRC has been shown to withstand 139 los/in while the wood control withheld 123 lbs/in, meaning the NRC withstands 13% more withdrawal (pullout) force. With ring shank nails, the NRC has been shown to withstand 201 lbs/in, while the wood control withstands 339 lbs/in. For a standard wood screw, the NRC has been shown to withstand 439 lbs/in, while the wood control withstands 824 lbs/in. It was also found that the NRC required, at maximum, approximately 350 lbs at a depth of 1 inch, while the wood control required 264 lbs at the same depth.

TABLE 17

| | | |
|---|---|---|
| | | Wood |
| | Nailable | Control |
| Test/Data | Rubber Concrete | (Spruce) |

Bending Moment Test

| | | |
|---|---|---|
| Point Load at Failure (lbs) | 1,818 (5-day cure) | 2,042 |
| Bending Moment Failure (lbs-in) | 2,727 | 3,063 |
| Failure Mode | Ductile | Brittle |
| Allowable Load (lbs) | 1,088 | 1,021 |
| Allowable Bending Moment (lbs-in) | 1,633 | 1,532 |
| Deflection at 1040 lbs (in, L/#) | 0.093, L/65 | 0.138, L/43 |

Withdrawal (Pullout) Test
Smooth Shank

| | | |
|---|---|---|
| Nail Withdrawal (Pullout) | 226 | 200 |
| Average (lbs) | | |
| Nail Embedment (in) | 1.625 | 1.625 |
| Nail Withdrawal (Pullout) | 139 | 123 |
| Average (lbs/in) | | |

Ring Shank

| | | |
|---|---|---|
| Nail Withdrawal (Pullout) | 326 | 551 |
| Average (lbs) | | |
| Nail Embedment (in) | 1.625 | 1.625 |
| Nail Withdrawal (Pullout) | 201 | 339 |
| Average (lbs/in) | | |

Screw Shank

| | | |
|---|---|---|
| Nail Withdrawal (Pullout) | 714 | 1,339 |
| Average (lbs) | | |
| Nail Embedment (in) | 1.625 | 1.625 |
| Nail Withdrawal (Pullout) | 439 | 824 |
| Average (lbs/in) | | |

Nail Insertion

| | | |
|---|---|---|
| Maximum force required, 1- | 350 | 264 |
| inch depth (lbs) | | |

### EXEMPLARY ASPECTS

In view of the described processes and compositions, hereinbelow are described certain more particularly described aspects of the disclosures. These particularly recited aspects should not, however, be interpreted to have any limiting effect on any different claims containing different or more general teachings described herein or that the “particular” aspects are somehow limited in some way other than the inherent meanings of the language and formulas literally used therein.
Example 1: A concrete composition comprising: a) a cement in an amount of about 25 wt % to about 70 wt % based on a total mass of dry material; b) a rubber in an amount of about 15 wt % to about 35 wt % on a total mass of dry material; and c) fine aggregates in an amount of about 10 wt % to about 35 wt % on a total mass of dry material; wherein the concrete composition is substantially free of coarse aggregates.
Example 2: The concrete composition of any examples herein, particularly example 1, the rubber is virgin and/or recycled.
Example 3: The concrete composition of any examples herein, particularly example 2, wherein the recycled rubber is post-consumer or post-manufacturing.
Example 4: The concrete composition of any examples herein, particularly example 2 or 3, wherein the recycled rubber comprises an amount of recycled materials other than rubber.
Example 5: The concrete composition of any examples herein, particularly examples 2-4, wherein the recycled rubber comprises recycled tires, tire buffing, recycled conveyor belts, rubber clothing, rubber gloves, rubber mats, rubber flooring, rubber seals, rubber gaskets, rubber hoses, or any combination thereof.
Example 6: The concrete composition of any examples herein, particularly examples 1-5, wherein the rubber has a particle size no greater than about 0.5 inches.
Example 7: The concrete composition of any examples herein, particularly examples 1-6, wherein the rubber comprises natural rubber, natural polyisoprene, synthetic polyisoprene, styrene-butadiene rubber, butadiene rubber, butyl rubber, halogenated butyl rubber, nitrile rubber, hydrogenated nitrile rubber ethylene propylene diene rubber, ethylene propylene rubber, chloroprene, polychloroprene, neoprene, silicone rubber, fluorosilicone rubber, fluoroelastomers, perfluloroelasomers, polyether block amides, polysulfide rubber, ethylene-vinyl acetate, chlorusulfonated polyethylene, epichlorhydrin rubber, inorganic rubber, or any combination thereof.
Example 8: The concrete composition of any examples herein, particularly examples 1-7, further comprising water in an amount of about 20 wt % to about 40 wt % based on the water-to-cement ratio.
Example 8: The concrete composition of any examples herein, particularly examples 1-7, further comprising one or more fillers, plasticizers, water-reducing agents, pumping agents, air entrainers, set retarders, fire retardants, water repellants, defoamers, antifreeze agents, expanding agents, curing agents, coloring additives, anti-dispersant agents, mold release agents, antimicrobial agents, fire-retardants, antifungal agents, insect- and animal-repellant agents, anti-corrosion additive, adhesive additives, or any combination thereof.
Example 9: The concrete composition of any examples herein, particularly example 8, wherein the plasticizers are present in an amount of about 0.25 wt % to about 8 wt % based on the weight of the cement.
Example 10: The concrete composition of any examples herein, particularly examples 8 and 9, wherein the one or more plasticizers comprise lignosulfonates, naphthalene, sulfonated naphthalene formaldehyde (SNF), melamine sulfonate-based superplasticizer, polycarboxylate ether superplasticizer (PCE), just polycarboxylate (PC), polycarboxylate superplasticizer monomer in ether mode (TPEG-HPEG) or any combination thereof.
Example 11: The concrete composition of any examples herein, particularly examples 8-10, wherein the filler is present up to about 300 wt % based on the weight of cement.
Example 12: The concrete composition of any examples herein, particularly example 11, wherein the filler comprises one or more of calcium carbonate, flyash, pozzolanic ash, calcium carbonate, aluminum trihydrate, talc, nano-clay, barium sulfate, barite, barite glass fiber, fiberglass, glass powder, glass cullet, metal powder, alumina, hydrated alumina, clay, magnesium carbonate, calcium sulfate, silica, glass, fumed silica, carbon black, graphite, cement dust, feldspar, nepheline, magnesium oxide, zinc oxide, aluminum silicate, calcium silicate, titanium dioxide, titanates, glass microspheres, chalk, calcium oxide, and any combination thereof.
Example 13: The concrete composition of any examples herein, particularly examples 8-12, wherein the fire-retardant comprise aluminum trihydrate (ATH), chlorinated tris [tris(1,3-dichloro-2-propyl)phosphate, TDCPP, and TDCIPP], Pentabromodiphenyl ether (PentaBDE) mixture [DE-71 (technical grade)], Tetrabromobisphenol A (TBBPA), Tris(2-chloroethyl) phosphate (TCEP), or any combination thereof.
Example 14: An article comprising a concrete composition comprising: a) a cement in an amount of about 25 wt % to about 70 wt % based on a total mass of dry material; b) a rubber in an amount of about 15 wt % to about 35 wt % on a total mass of dry material; c) fine aggregates in an amount of about 10 wt % to about 35 wt % on a total mass of dry material; and d) water in an amount of about 20 wt % to about 40 wt % on a water-to-cement ratio; wherein the concrete composition is substantially free of coarse aggregates.
Example 15: The article of any examples herein, particularly example 14, wherein the article is nailable and/or screwable and exhibits a nail and/or screw insertion shear stress of about 500 to about 1200 pounds per square inch and nail and/or screw withdrawal or pullout stress of about 150 to about 1450 pounds per square inch.
Example 16: The article of any examples herein, particularly example 15, wherein the nail withdrawal or pullout stress is about 150 to about 500 pounds per square inch for smooth shank steel nails.
Example 17: The article of any examples herein, particularly examples 15 or 16, wherein the nail withdrawal or pullout stress is about 200 to about 650 pounds per square inch for ring shank steel nails.
Example 18: The article of any examples herein, particularly examples 15-17, wherein the screw withdrawal or pullout stress is about 400 to about 1450 pounds per square inch for wood screws.
Example 19: The article of any examples herein, particularly examples 14-18, wherein the article is adapted to receive wood screws screwed with a hand screwdriver.
Example 20: The article of any examples herein, particularly examples 14-19, wherein the article is adapted to receive nails or staples.
Example 21: The article of any examples herein, particularly examples 15-20, wherein the rubber has a particle size no greater than about 0.5 inches.
Example 22: The article of any examples herein, particularly examples 15-21, wherein the rubber is virgin and/or recycled.
Example 23: The article of any examples herein, particularly example 22, wherein the recycled rubber is post-consumer or post-manufacturing.
Example 24: The article of any examples herein, particularly example 22 or 23, wherein the recycled rubber comprises an amount of recycled materials other than rubber.
Example 25: The article of any examples herein, particularly examples 22-24, wherein the recycled rubber comprises recycled tires, tire buffing, recycled conveyor belts, rubber clothing, rubber gloves, rubber mats, rubber flooring, rubber seals, rubber gaskets, rubber hoses, rubber boots, or any combination thereof.
Example 26: The article of any examples herein, particularly examples 22-25, wherein the rubber comprises natural rubber, natural polyisoprene, synthetic polyisoprene, styrene-butadiene rubber, butadiene rubber, butyl rubber, halogenated butyl rubber, nitrile rubber, hydrogenated nitrile rubber ethylene propylene diene rubber, ethylene propylene rubber, chloroprene, polychloroprene, neoprene, silicone rubber, fluorosilicone rubber, fluoroelastomers, perfluloroelasomers, polyether block amides, polysulfide rubber, ethylene-vinyl acetate, chlorusulfonated polyethylene, epichlorhydrin rubber, inorganic rubber, or any combination thereof.
Example 27: The article of any examples herein, particularly examples 20-26, wherein the concrete composition further comprises one or more fillers, plasticizers, water-reducing agents, pumping agents, air entrainers, set retarders, fire retardants, water repellants, defoamers, antifreeze agents, expanding agents, curing agents, coloring additives, anti-dispersant agents, mold release agents, antimicrobial agents, fire-retardants, antifungal agents, insect- and animal-repellant agents, anti-corrosion additive, adhesive additives, or any combination thereof.
Example 28: The article of any examples herein, particularly example 27, wherein the plasticizers are present in an amount of about 0.25 wt % to about 8 wt % based on the weight of the cement.
Example 29: The article of any examples herein, particularly example 27 or 28, wherein the one or more plasticizers comprise lignosulfonates, naphthalene, sulfonated naphthalene formaldehyde (SNF), melamine sulfonate-based superplasticizer, polycarboxylate ether superplasticizer (PCE), just polycarboxylate (PC), polycarboxylate superplasticizer monomer in ether mode (TPEG-HPEG) or any combination thereof.
Example 30: The article of any examples herein, particularly examples 27-29, wherein the filler is present up to about 300 wt % based on the weight of the cement.
Example 31: The article of any examples herein, particularly, example 30, wherein the filler comprises one or more of calcium carbonate, flyash, pozzolanic ash, calcium carbonate, aluminum trihydrate, talc, nano-clay, barium sulfate, barite, barite glass fiber, fiberglass, glass powder, glass cullet, metal powder, alumina, hydrated alumina, clay, magnesium carbonate, calcium sulfate, silica, glass, fumed silica, carbon black, graphite, cement dust, feldspar, nepheline, magnesium oxide, zinc oxide, aluminum silicate, calcium silicate, titanium dioxide, titanates, glass microspheres, chalk, calcium oxide, and any combination thereof.
Example 32: The article of any examples herein, particularly examples 14-31, wherein the fire-retardant comprise aluminum trihydrate (ATH), chlorinated tris [tris(1,3-dichloro-2-propyl)phosphate, TDCPP, and TDCIPP], Pentabromodiphenyl ether (PentaBDE) mixture [DE-71 (technical grade)], Tetrabromobisphenol A (TBBPA), Tris(2-chloroethyl) phosphate (TCEP), or any combination thereof.
Example 33: The article of any examples herein, particularly, examples 14-32, wherein the article exhibits a tensile strength of about 40 to about 200 pounds per square inch.
Example 34: The article of any examples herein, particularly, examples 14-33, wherein the article exhibits an ultimate compressive strength of about 150 to about 2000 pounds per square inch.
Example 35: The article of any examples herein, particularly, examples 14-34, wherein the article comprises at least one concrete composition reinforcing element.
Example 36: The article of any examples herein, particularly, example 35, wherein the at least one concrete composition reinforcing element is a shear reinforcing element and/or a longitudinal reinforcing element.
Example 37: The article of any examples herein, particularly, example 35 or 36, wherein the at least one concrete composition reinforcing element comprises one or more metal wires.
Example 38: The article of any examples herein, particularly, examples 35-37, wherein the at least one concrete composition reinforcing element comprises steel, galvanized steel, stainless steel, adhesives, or any combination thereof.
Example 39: The article of any examples herein, particularly, examples 14-38, wherein the article is configured to withstand a temperature of about −50° C. to about 50° C.
Example 40: The article of any examples herein, particularly, examples 14-39, wherein the article is substantially unchanged when exposed to a moisture from 0% to 100% for at least 5 years.
Example 41: The article of any examples herein, particularly, examples 14-40, wherein the article is a fence post, a desk slab, a shelf, a floor slab, a roof slab, a siding slab, exterior siding, structural columns, structural beams, fence boards, garden beds, landscape timbers, stakes, trellises, guard rail posts, concrete masonry units, concrete block or cinder blocks, patching compound, cribbing, dunnage, pallets, crates, railroad ties, vaults, pipes, culverts, handrails, joists, rafters, trusses, fire retardant structural members (firewall), furniture, cabinets, deck boards, moldings, baseboards, animal pens, pavers, fence horizontal beams, fence pickets, racks, mezzanines, flooring, telephone poles, power poles, roofing tiles, sheathing, work benches, bridges, scaffolding, kitchen counters, or any combination thereof.
Example 42: The article of any examples herein, particularly, examples 14-41, wherein the article is substantially bacteria-resistant, fungal resistant, insect-damage resistant, crustaceans resistant, or any combination thereof.
Example 43: A method comprising: a) mixing a composition comprising: i) a cement in an amount of about 25 wt % to about 70 wt % based on a total mass of dry material; ii) a rubber in an amount of about 15 wt % to about 35 wt % on a total mass of dry material; and ill) fine aggregates in an amount of about 10 wt % to about 35 wt % on a total mass of dry material to form a concrete composition; b) mixing concrete composition with water in an amount of about 20 wt % to about 40 wt % on a water-to-cement ratio to form concrete.
Example 44: The method of any examples herein, particularly, example 43, wherein the rubber is soaked in water prior to mixing with the fine aggregate or cement.
Example 45: The method of any examples herein, particularly, examples 43 or 44, further comprising pouring the concrete into a mold to form an article.
Example 46: The method of any examples herein, particularly, examples 43-45, wherein the mold comprises at least one concrete reinforcing element.
Example 47: The method of any examples herein, particularly, examples 43-46, wherein the concrete is formed in situ or pre-cast.
Example 48: The method of any examples herein, particularly, examples 46-47, wherein the method further comprises pre-tensioning of the concrete.
Example 49: The method of any examples herein, particularly, examples 46-48, wherein the method further comprises post-tensioning of the concrete.
Example 50: The method of any examples herein, particularly, examples 43-49, wherein the method further comprises patching an article with the concrete.
Example 51: The method of any examples herein, particularly, examples 43-50, wherein the method further comprises applying the concrete pneumatically.
Example 52: A method comprising nailing one or more nails into the article of any examples herein, particularly, examples 14-42.
Example 53: The method of any examples herein, particularly, example 52, wherein the nailing does not comprise use of a powered nail gun.
Example 54: A method comprising screwing one or more screws into the article of any examples herein, particularly, examples 14-42.
Example 55: The method of any examples herein, particularly, example 54, wherein the screwing does not comprise forming a pilot hole in the article.
Example 56: The method of any examples herein, particularly, example 54 or 55, wherein the screwing comprises use of a hand screw.
Example 57: The method of any examples herein, particularly, examples 54-56, wherein the one or more screws are wood screws.

What is claimed is:

1. A concrete composition comprising:
a) a cement in an amount of about 25 wt % to about 70 wt % based on a total mass of dry material;
b) a rubber in an amount of about 15 wt % to about 35 wt % on a total mass of dry material; and
c) fine aggregates in an amount of about 10 wt % to about 35 wt % on a total mass of dry material;
wherein the concrete composition is substantially free of coarse aggregates.

2. The concrete composition of claim 1, wherein the rubber is virgin and/or recycled and has a particle size no greater than about 0.5 inches.

3. The concrete composition of claim 1, wherein the rubber comprises natural rubber, natural polyisoprene, synthetic polyisoprene, styrene-butadiene rubber, butadiene rubber, butyl rubber, halogenated butyl rubber, nitrile rubber, hydrogenated nitrile rubber ethylene propylene diene rubber, ethylene propylene rubber, chloroprene, polychloroprene, neoprene, silicone rubber, fluorosilicone rubber, fluoroelastomers, perfluloroelasomers, polyether block amides, polysulfide rubber, ethylene-vinyl acetate, chlorusulfonated polyethylene, epichlorhydrin rubber, inorganic rubber, or any combination thereof.

4. The concrete composition of claim 1, further comprising water in an amount of about 20 wt % to about 40 wt % based on the water-to-cement ratio.

5. The concrete composition of claim 1 further comprising one or more fillers, plasticizers, water-reducing agents, pumping agents, air entrainers, set retarders, fire retardants, water repellants, defoamers, antifreeze agents, expanding agents, curing agents, coloring additives, anti-dispersant agents, mold release agents, antimicrobial agents, fire-retardants, antifungal agents, insect- and animal-repellant agents, anti-corrosion additive, adhesive additives, or any combination thereof.

6. An article comprising a concrete composition comprising:
a) a cement in an amount of about 25 wt % to about 70 wt % based on a total mass of dry material;
b) a rubber in an amount of about 15 wt % to about 35 wt % on a total mass of dry material;
c) fine aggregates in an amount of about 10 wt % to about 35 wt % on a total mass of dry material; and
d) water in an amount of about 20 wt % to about 40 wt % on a water-to-cement ratio;
wherein the concrete composition is substantially free of coarse aggregates.

7. The article of claim 6, and wherein the article is nailable and/or screwable and exhibits a nail and/or screw insertion shear stress of about 500 to about 1200 pounds per square inch and nail and/or screw withdrawal or pullout stress of about 150 to about 1450 pounds per square inch.

8. The article of claim 6, wherein the rubber has a particle size no greater than about 0.5 inches and wherein the rubber is virgin and/or recycled.

9. The article of claim 6, wherein the concrete composition further comprises one or more of fillers, plasticizers, water-reducing agents, pumping agents, air entrainers, set retarders, fire retardants, water repellants, defoamers, antifreeze agents, expanding agents, curing agents, coloring additives, anti-dispersant agents, mold release agents, antimicrobial agents, fire-retardants, antifungal agents, insect- and animal-repellant agents, anti-corrosion additive, adhesive additives, or any combination thereof.

10. The article of claim 6, wherein the article exhibits a tensile strength of about 40 to about 200 pounds per square inch and/or wherein the article exhibits an ultimate compressive strength of about 150 to about 2000 pounds per square inch.

11. The article of claim 6, wherein the article comprises at least one concrete composition reinforcing element.

12. The article of claim 11, wherein the at least one concrete composition reinforcing element is a shear reinforcing element and/or a longitudinal reinforcing element.

13. The article of claim 6, wherein the article is configured to withstand a temperature of about −50° C. to about 50° C.

14. The article of claim 6, wherein the article is substantially unchanged when exposed to a moisture from 0% to 100% for at least 5 years.

15. The article of claim 6, wherein the article is a fence post, a desk slab, a shelf, a floor slab, a roof slab, a siding slab, exterior siding, structural columns, structural beams, fence boards, garden beds, landscape timbers, stakes, trellises, guard rail posts, concrete masonry units, concrete block or cinder blocks, patching compound, cribbing, dunnage, pallets, crates, railroad ties, vaults, pipes, culverts, handrails, joists, rafters, trusses, fire retardant structural members (firewall), furniture, cabinets, deck boards, moldings, baseboards, animal pens, pavers, fence horizontal beams, fence pickets, racks, mezzanines, flooring, telephone poles, power poles, roofing tiles, sheathing, work benches, bridges, scaffolding, kitchen counters, or any combination thereof.

16. A method comprising:
a) mixing a composition comprising:
i) a cement in an amount of about 25 wt % to about 70 wt % based on a total mass of dry material;
ii) a rubber in an amount of about 15 wt % to about 35 wt % on a total mass of dry material; and
iii) fine aggregates in an amount of about 10 wt % to about 35 wt % on a total mass of dry material
to form a concrete composition
b) mixing concrete composition with water in an amount of about 20 wt % to about 40 wt % on a water-to-cement ratio to form concrete.

17. The method of claim 16, wherein the rubber is soaked in water prior to mixing with the fine aggregate or cement.

18. The method of claim 16, further comprising pouring the concrete into a mold to form an article.

19. The method of claim 18, wherein the mold comprises at least one concrete reinforcing element.

20. The method of claim 16, wherein the method further comprises patching an article with the concrete.
